(19) United States
(12) Patent Application Publication
(10) Pub. No.: US 2026/0072831 A1
(43) Pub. Date: Mar. 12, 2026

(54) SYSTEMS, METHODS, AND APPARATUS FOR OVER-PROVISIONING ALLOCATION AND GARBAGE COLLECTION TRIGGERING IN A STORAGE DEVICE

(71) Applicant: Samsung Electronics Co., Ltd., Gyeonggi-do (KR)

(72) Inventors: Daniel Lee HELMICK, Erie, CO (US); Vipin Kumar AGRAWAL, San Jose, CA (US); Mark Allen GAERTNER, Fort Myers, FL (US)

(21) Appl. No.: 19/325,016

(22) Filed: Sep. 10, 2025

Related U.S. Application Data
(60) Provisional application No. 63/692,898, filed on Sep. 10, 2024.

(51) Int. Cl. G06F 12/02

(52) U.S. Cl. CPC G06F 12/0253

(57) ABSTRACT

An apparatus and method of a storage device including a storage medium are provided. An apparatus may include a storage device comprising a storage medium, and a controller configured to provide a first over-provisioning (OP) pool of storage units of the storage medium for use by a first reclaim unit handle (RUH); provide a second OP pool of storage units of the storage medium for use by a second RUH, wherein the first OP pool and the second OP pool are distinct from each other; perform a first storage operation associated with the first RUH using the first OP pool; and perform a second storage operation associated with the second RUH using the second OP pool.

### REFERENCE TO RELATED APPLICATION

This application claims priority to, and the benefit of, U.S. Provisional Patent Application Ser. No. 63/692,898, which was filed in the U.S. Patent and Trademark Office on Sep. 10, 2024, the entire content of which is incorporated herein by reference.

### TECHNICAL FIELD

This disclosure relates generally to storage devices, and more specifically to systems, methods, and apparatus for over-provisioning (OP) allocation and garbage collection (GC) triggering in storage devices.

### BACKGROUND

A storage device such as a solid state drive (SSD) may store data in storage media that may be implemented with nonvolatile memory (NVM). In some NVM, data may be updated by erasing the memory in which the data is stored and re-writing new data in the erased memory. Some NVM may be written and/or read in units of pages but erased in units of blocks that may include multiple pages. Thus, to update data stored in a page of NVM, valid data stored in other pages in the same block may be copied to a different block to prevent loss of the valid data when the block is erased.

The above information disclosed in this Background section is only for enhancement of understanding of the background of the inventive principles and therefore it may contain information that does not constitute prior art.

### SUMMARY

In accordance with an embodiment of the disclosure, an apparatus may include a storage device comprising a storage medium, and a controller configured to provide a first over-provisioning (OP) pool of storage units of the storage medium for use by a first reclaim unit handle (RUH); provide a second OP pool of storage units of the storage medium for use by a second RUH, wherein the first OP pool and the second OP pool are distinct from each other; perform a first storage operation associated with the first RUH using the first OP pool; and perform a second storage operation associated with the second RUH using the second OP pool.

In accordance with another embodiment of the disclosure, a method performed by a storage device including a storage medium may include providing a first over-provisioning (OP) pool of storage units of the storage medium for use by a first reclaim unit handle (RUH); providing a second OP pool of storage units of the storage medium for use by a second RUH, wherein the first OP pool and the second OP pool are distinct from each other, performing a first storage operation associated with the first RUH using the first OP pool; and performing a second storage operation associated with the second RUH using the second OP pool.

In accordance with another embodiment of the disclosure, an apparatus may include a storage device comprising a storage medium, and a controller configured to provide an over-provisioning (OP) pool of storage units of the storage medium for use by a first reclaim unit handle (RUH) and a second RUH; perform a first storage operation associated with the first RUH using the OP pool of storage units; and perform a second storage operation associated with the second RUH using the OP pool of storage units.

### BRIEF DESCRIPTION OF THE DRAWINGS

In the following section, the aspects of the subject matter disclosed herein will be described with reference to exemplary embodiments illustrated in the figures, in which:

FIG. 1A illustrates an embodiment of a data placement scheme for a storage device in a first data placement state in accordance with example embodiments of the disclosure;

FIG. 1B illustrates the embodiment of the data placement scheme illustrated in FIG. 1A in a second data placement state in accordance with example embodiments of the disclosure;

FIG. 1C illustrates the embodiment of the data placement scheme illustrated in FIG. 1A in a third data placement state in accordance with example embodiments of the disclosure;

FIG. 1D illustrates the embodiment of the data placement scheme illustrated in FIG. 1A in a fourth data placement state in accordance with example embodiments of the disclosure;

FIG. 1E illustrates the embodiment of the data placement scheme illustrated in FIG. 1A in a fifth data placement state in accordance with example embodiments of the disclosure;

FIG. 2A illustrates an embodiment of a flexible data placement (FDP) scheme for a storage device in a first data placement state in accordance with example embodiments of the disclosure;

FIG. 2B illustrates the embodiment of the data placement scheme illustrated in FIG. 2A in a second data placement state in accordance with example embodiments of the disclosure;

FIG. 2C illustrates the embodiment of the data placement scheme illustrated in FIG. 2A in a third data placement state in accordance with example embodiments of the disclosure;

FIG. 2D illustrates the embodiment of the data placement scheme illustrated in FIG. 2A in a fourth data placement state in accordance with example embodiments of the disclosure;

FIG. 3 illustrates an embodiment of an FDP scheme having namespaces corresponding to reclaim groups (RGs) in accordance with example embodiments of the disclosure;

FIG. 4 illustrates an embodiment of an FDP scheme having reclaim unit handles in accordance with example embodiments of the disclosure;

FIG. 5 illustrates another embodiment of an FDP scheme in accordance with example embodiments of the disclosure;

FIG. 6 illustrates an embodiment of a method for servicing a write command using an FDP scheme in accordance with example embodiments of the disclosure;

FIG. 7 illustrates an embodiment of a storage device with FDP in accordance with example embodiments of the disclosure;

FIG. 8 illustrates another embodiment of a storage device with FDP in accordance with example embodiments of the disclosure;

FIG. 9A illustrates an embodiment of an FDP scheme with reference modification in a first data placement state in accordance with example embodiments of the disclosure;

FIG. 9B illustrates the embodiment of the data placement scheme illustrated in FIG. 9A in a second data placement state in accordance with example embodiments of the disclosure;

FIG. 9C illustrates the embodiment of the data placement scheme illustrated in FIG. 9A in a third data placement state in accordance with example embodiments of the disclosure;

FIG. 9D illustrates the embodiment of the data placement scheme illustrated in FIG. 9A in a fourth data placement state in accordance with example embodiments of the disclosure;

FIG. 10 illustrates an embodiment of an initial isolation scheme for an FDP scheme for a storage device in accordance with example embodiments of the disclosure;

FIG. 11 illustrates an embodiment of a persistent isolation scheme for an FDP scheme for a storage device in accordance with example embodiments of the disclosure;

FIG. 12 illustrates an example storage configuration in accordance with example embodiments of the disclosure;

FIG. 13 illustrates a method performed by a storage device in accordance with example embodiments of the disclosure;

FIG. 14 illustrates another embodiment of a storage device with FDP in accordance with example embodiments of the disclosure;

FIG. 15 illustrates an example embodiment of a host apparatus in accordance with example embodiments of the disclosure;

FIG. 16 illustrates an example embodiment of a storage device in accordance with example embodiments of the disclosure; and

FIG. 17 illustrates an embodiment of a method for a storage device in accordance with example embodiments of the disclosure.

### DETAILED DESCRIPTION

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Also, depending on the context of discussion herein, a singular term may include the corresponding plural forms and a plural term may include the corresponding singular form. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms and a plural term may include the corresponding singular form. It is further noted that various figures (including component diagrams) shown and discussed herein are for illustrative purpose only, and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and case of discussion only; it does not imply that the construction or architectural details of such components or units are the same across all embodiments or such commonly-referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module” refers to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system on-a-chip (SoC), an assembly, and so forth.

As used herein, the term “logic” may refer to a set of instructions, rules, or algorithms that dictate how a controller or processor, such as a computer processor, operates to perform a specific function. For example, logic may be implemented via software and used to define how the controller processes inputs and generates outputs to achieve the desired result.

A storage device may implement an FDP scheme that allows a host to arrange data into one or more reclaim units (RUs) in the storage device. An RU may be implemented with a portion of physical storage media (e.g., one or more erase blocks (EBs)) that may be erased as a unit. This may reduce write amplification, e.g., by allowing the host to place data that is likely to be deallocated at the same time in the same RU. Herein, the terms RU and superblock may be used interchangeably.

Write amplification factor (WAF) can be based on a phenomenon that occurs when the amount of data written to storage media is more than the intended amount. This can happen in flash memory and SSDs. WAF occurs when a host computer writes a different amount of logical data than the amount of physical data written. In other words, WAF occurs when the actual amount of written physical data differs from the amount of logical data that is written by the host computer. WAF can be caused by a disconnect between the device and the host. The host may not have enough information to understand the device's physical layout or know about data that is often used together. WAF can negatively affect the performance and durability of storage and can also shorten the life cycle of a device.

In some examples, WAF is a multiplier applied to data during write operations. WAF is the factor by which written data is amplified. WAF is calculated by dividing the amount of data written to flash media by the amount of data written by the host. An ideal SSD has a WAF of 1.0 (e.g., WAF=1). A WAF of 1 indicates there is no write amplification. SSDs may use GC to reclaim unused space, which can also lead to write amplification.

Depending on the implementation details, however, one or more ongoing operations and/or conditions of the storage device may adversely affect one or more operations involving an RU. For example, the host may send a write command that specifies an RU for storing data associated with the write command. However, the storage device may have implemented the specified RU with physical storage media (e.g., an NVM die) that may be busy with a read operation. Thus, the write operation requested by the host may be delayed until the read operation is completed.

In an FDP scheme in accordance with example embodiments of the disclosure, a storage device may select an RU based on one or more operations and/or conditions of the storage device. For example, if a storage device receives a write command that specifies an RU for storing data associated with the write command, and the specified RU is implemented with physical storage media that is busy with a read operation, the storage device may select a different RU for storing the data associated with the write command. Depending on the implementation details, this may reduce or eliminate a delay in processing a write command associated with waiting for the read operation to complete.

In some embodiments, an RU may appear to a host as a logical representation of storage media identified by an RU handle (RUH). The storage device may implement the RU corresponding to the RUH using physical storage media determined by the storage device.

In some embodiments, one or more RUs may be arranged in one or more RGs. In such an embodiment, a host may specify an RU using an RG identifier (e.g., that may indicate an RG) and an RUH (e.g., that may indicate an RU within the RG). Moreover, in such an embodiment, an RUH may map to corresponding RUs in more than one RG. For example, an RUH may map to an RU in each RG. Thus, in some embodiments having RGs, if a storage device receives a command that specifies an RUH but not a valid RG indicator, the storage device may select an RU by selecting an RG and using the RU that the RUH maps to within the selected RG. In some embodiments, a command may specify an RUH indirectly, e.g., using a placement handle that, in turn, may map to an RG and an RUH. Additionally, or alternatively, if a storage device receives a command that does not specify an RG or an RUH, the storage device may select a RU, e.g., using a default RUH and/or a default placement handle. Additionally. or alternatively, if a storage device receives a command that specifies a valid RG and/or a valid RUH, but the RG does not include a usable RG (e.g., because all of the RUs in the RG have been used), the storage device may select an RG and/or RU, e.g., using a default RG, a default RUH, and/or a default placement handle.

In some embodiments, the storage device may select the RG, and therefore, the corresponding RU within the selected RG, based on one or more operations and/or conditions of the storage device.

In some embodiments, a storage device may select an RU and/or an RG based on an ongoing operation such as a die operation, a channel operation, a storage device controller operation, etc. For example, if a storage device receives a write command that specifies an RUH that currently maps to an RU and/or an RG that is implemented with physical storage media that is currently busy with an operation (e.g., write, read, and/or erase) that may delay the write command, the storage device may select a different RU and/or RG that may be available sooner to use for the write command. As another example, if an RUH that currently maps to an RU and/or RG having a relatively long queue of commands, the storage device may select a different RU and/or RG that may have a command queue with no or fewer pending commands. As a further example, to service a write command, a storage device may select an RU and/or RG based on an opportunistic status such as an NVM die that is approaching the completion of a programming cycle, an associated write buffer that is nearing a full word line, and/or an open block timer that is nearing expiration. As a further example, if a storage device receives a write command that specifies an RG that does not have adequate available space in one or more RUs to store new write data (e.g., the RG has run out of empty RUs), the storage device may select a different RG (and one or more RUs with the selected RG).

Additionally, or alternatively, a storage device may select an RU and/or RG based on a condition of storage media that may be used by the RU and/or RG. For example, in some embodiments, a storage device may avoid selecting an RU and/or RG in which an NVM die may be exhibiting end-of-life (EOL) behavior such as relatively low operation speed, relatively high bit error accumulation rate, sense voltage shifts, etc. Additionally, or alternatively, to service a write command, a storage device may select an RU and/or RG in which the physical storage media may exhibit relatively young behavior.

Additionally, or alternatively, a storage device may select an RU and/or an RG based on one or more indications received from a host. For example, to service a write command received from a host, a storage device may consider any number of the following indications it may receive from the host to select an RU and/or an RG: emphasis on read quality-of-service (QoS), emphasis on read bandwidth (BW), emphasis on write BW, read and/or write BW throttle targets, whether any write data associated with the write command is relatively hot and/or cold, whether some or all of the write data associated with the write command may be deallocated together, and/or the like.

This disclosure encompasses numerous inventive principles relating to FDP. The principles disclosed herein may have independent utility and may be embodied individually, and not every embodiment may utilize every principle. Moreover, the principles may also be embodied in various combinations, some of which may amplify some benefits of the individual principles in a synergistic manner.

For purposes of illustration, some embodiments may be described in the context of specific implementation details such as storage devices implemented with SSDs using not-AND (NAND) flash memory, a NVM Express (NVMe) protocol, and/or the like. The inventive principles, however, are not limited to these or any other implementation details. For example, some embodiments may implement storage media with flash memory, magnetic media, storage class memory (SCM), and/or the like, or any combination thereof.

In some embodiments in which storage media may be implemented at least partially with flash memory, an RU may refer to one or more EBs, NVM devices (e.g., NVM dies) and/or the like, or any combination thereof, and an RG may refer to one or more RUs, one or more NVM device partitions (e.g., planes), one or more NVM devices (e.g., NVM dies), one or more storage devices (e.g., storage drives), and/or the like, or any combination thereof.

In some embodiments in which storage media may be implemented at least partially with magnetic media (e.g., shingled magnetic recording (SMR) media), an RU may refer to one or more shingle sections, zones, sectors, tracks, and/or the like, or any combination thereof, and an RG may refer to one or more disks (e.g., drives), platters, tracks, zones, sectors, shingle sections, and/or the like, or any combination thereof.

In some embodiments in which storage media may be implemented at least partially with storage class memory (e.g., magnetoresistive random-access memory (MRAM), resistive random-access memory (ReRAM), phase change memory (PCM), cross-gridded NVM, memory with bulk resistance change, and/or the like), an RU may refer to one or more banks, programming groups, and/or the like, or any combination thereof, and an RG may refer to one or more die, banks, programming groups, and/or the like, or any combination thereof.

As another example, the inventive principles are not limited to use with write commands, but may be applied to any type of request for a data operation involving data locality, for instance, in any type of scheme involving data that may be placed based on logical to physical mapping (e.g., a logical representation of physical storage media such as a logical block address (LBA)-to-physical block address (PBA) (or L2P) mapping). For example, a storage device may receive any type of data operation request such as a request for a write operation (e.g., a write command, write zeros, write ones, write uncorrectable, and/or the like), a copy operation, a deallocate operation (e.g., an unmap, a trim, and/or the like), a sanitize operation, an erase operation, a format operation, a compare and write operation (which may be referred to as a fused command, e.g., a pair of commands that may include a read command to read data for a comparison operation and a write command that may execute based on a result of the comparison operation), and/or the like. In some embodiments, a data operation request may include an indication relating to data locality in storage media (e.g., an RUH, a RG, and/or the like). Based on receiving a data operation request with an indication relating to data locality in storage media, the storage device may perform a corresponding data operation based on one or more operations and/or conditions of the storage device.

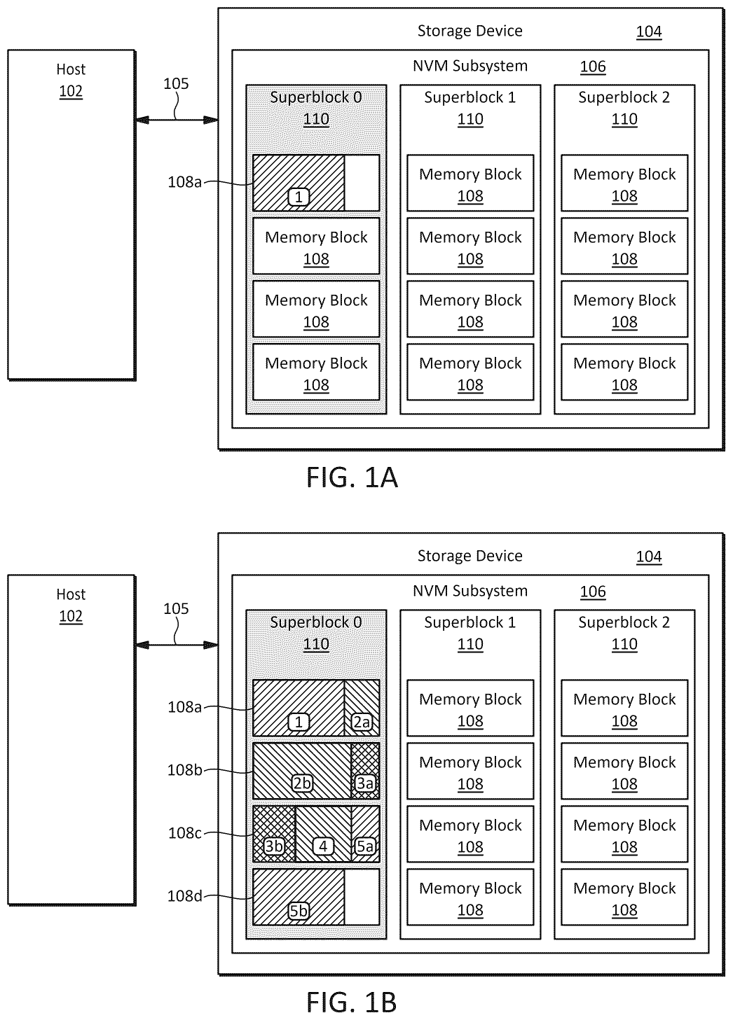

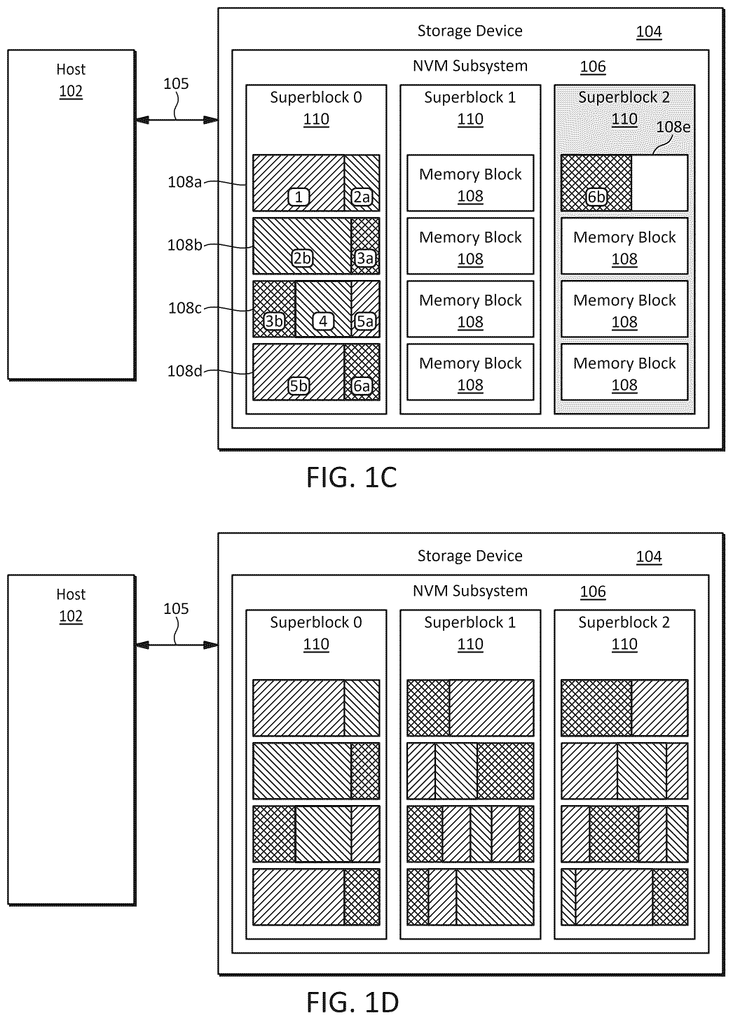

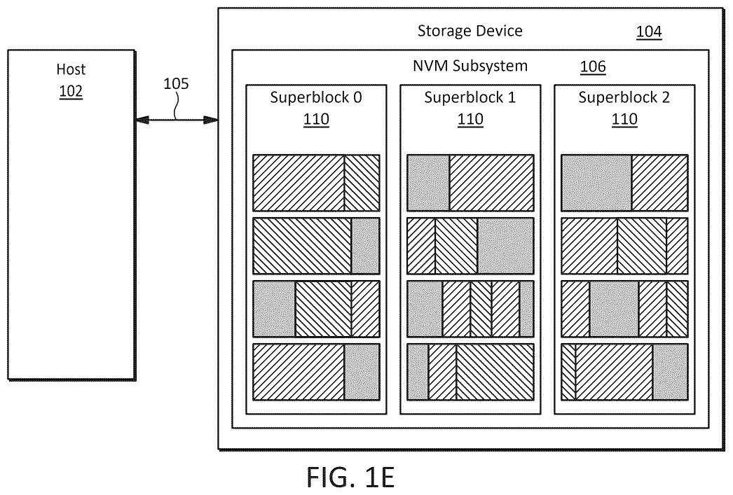

FIG. 1A illustrates an embodiment of a data placement scheme for a storage device in a first data placement state in accordance with example embodiments of the disclosure. FIG. 1B illustrates the embodiment of the data placement scheme illustrated in FIG. 1A in a second data placement state in accordance with example embodiments of the disclosure. FIG. 1C illustrates the embodiment of the data placement scheme illustrated in FIG. 1A in a third data placement state in accordance with example embodiments of the disclosure. FIG. 1D illustrates the embodiment of the data placement scheme illustrated in FIG. 1A in a fourth data placement state in accordance with example embodiments of the disclosure. FIG. 1E illustrates the embodiment of the data placement scheme illustrated in FIG. 1A in a fifth data placement state in accordance with example embodiments of the disclosure.

FIG. 1A, FIG. 1B, FIG. 1C, FIG. 1D, and/or FIG. 1E may be referred to collectively and/or individually as FIG. 1.

The embodiment illustrated in FIG. 1 may include a host 102 and a storage device 104 communicating using a communication connection 105. The storage device 104 may include storage media in an NVM subsystem 106 having memory blocks 108 arranged in superblocks 110. The memory blocks 108 may be implemented with NVM that may be erased in units of the blocks illustrated in FIG. 1 and thus may also be referred to as EBs. The memory blocks 108 may be programmed (e.g., written) and/or read in units of pages and/or word lines which may be smaller than memory blocks. The memory blocks 108 may be erased before pages and/or word lines of data may be written into them. The memory blocks 108 may be arranged in superblocks 110, for example, to simplify management of the blocks 108. Thus, the NVM illustrated in FIG. 1 may be erased in units of superblocks 110.

The storage device 104 may receive input and/or output (I/O or IO) requests (which may also be referred to as commands) from the host 102 to enable the host to access the NVM subsystem (e.g., write data into the storage media and/or read data from the storage media). The host 102 may divide the data into namespaces indicated by the different types of shading illustrated in FIG. 1. Specifically, data belonging to a first namespace (which may be indicated as namespace identifier 1 (NSID 1)) may be indicated by shading with diagonal lines from top right to bottom left, data belonging to a second namespace (which may be indicated as NSID 1) may be indicated by shading with diagonal lines from top left to bottom right, and data belonging to a third namespace (which may be indicated as namespace NSID 3) may be indicated by diagonal cross-shading. In some embodiments, in addition to namespaces, and/or as an alternative to namespaces, the host 102 may divide and/or arrange the data into groups based on LBAs, one or more applications that may use the data, host write traffic threads, and/or the like, for separating and/or managing data based on RUHs, RUs, erase units, and/or the like.

Referring to FIG. 1A, memory blocks 108 may initially be in an erased state as shown by the absence of shading. The NVM subsystem 106 may identify an erased superblock (e.g., Superblock 0 indicated by solid shading) into which write data may be placed. The storage device 104 may receive a first write command with write data belonging to NSID 3. The NVM subsystem 106 may place the data belonging to NSID 1 (indicated by the number 1 in a rounded rectangle) in a first memory block 108a of Superblock 0 as illustrated in FIG. 1A. (The number 1 may indicate a sequence in which the data may be placed rather than the NSID.)

Referring to FIG. 1B, the storage device 104 may continue receiving additional write commands from the host 102 with write data belonging to various namespaces. The NVM subsystem 106 may fill the memory blocks 108a-108d in Superblock 0 by placing the write data in the sequence indicated by the numbers in the rounded rectangles. In some cases, the quantity of write data is larger than the space remaining in a memory block. Thus, a first portion of the write data may be placed so as to fill the remaining space in a first memory block, and a second portion may be placed in an empty memory block. For example, as shown in FIG. 1B, based on receiving a second write command, a first portion 2a of data belonging to NSID 2 may be used to fill the remaining space in memory block 108a, and a second portion 2b of data belonging to NSID 2 may be placed in memory block 108b. The NVM subsystem 106 may continue placing write data into Superblock 0 until Superblock 0 is full or nearly full as shown in FIG. 1B.

Referring to FIG. 1C, the storage device 104 may receive a sixth write command with data belonging to NSID 3 that is too large to fit in the remaining space in memory block 108d in Superblock 0. Thus, the NVM subsystem 106 may select a new empty superblock (e.g., Superblock 2 indicated by solid shading) into which write data may be placed. The NVM subsystem 106 may use a first portion 6a of data belonging to NSID 3 to fill the remaining space in memory block 108d, and a second portion 6b of data belonging to NSID 3 may be placed in memory block 108e in Superblock 2. The NVM subsystem 106 may continue placing write data into Superblock 2, and then Superblock 1, with data belonging to different namespaces mixed within one or more superblocks as shown in FIG. 1D. Data belonging to different namespaces may be mixed within blocks 108 and/or superblocks 110, for example, because the host 102 may be unaware of, and/or have no control over, the manner in which the NVM subsystem 106 places data within the blocks 108 and/or superblocks 110.

The host 102 may divide data into namespaces, for example, to provide isolation between sources of data such as applications, processes, LBA range, and/or the like. Thus, the host 102 may deallocate some or all data belonging to a namespace at the same time, for example, when an application terminates.

FIG. 1E illustrates an example in which the host 102 has deallocated data belonging to the namespace indicated as NSID 3 which is shown with solid shading after deallocation. Reusing the deallocated storage space may involve erasing the deallocated storage space. However, because superblocks 110 may be erased as units, the NVM subsystem 106 may move the remaining valid data in a superblock to a different superblock to prevent loss of the valid data when the superblock is erased. Depending on the implementation details, this may result in write amplification that may reduce the useful life of the storage media.

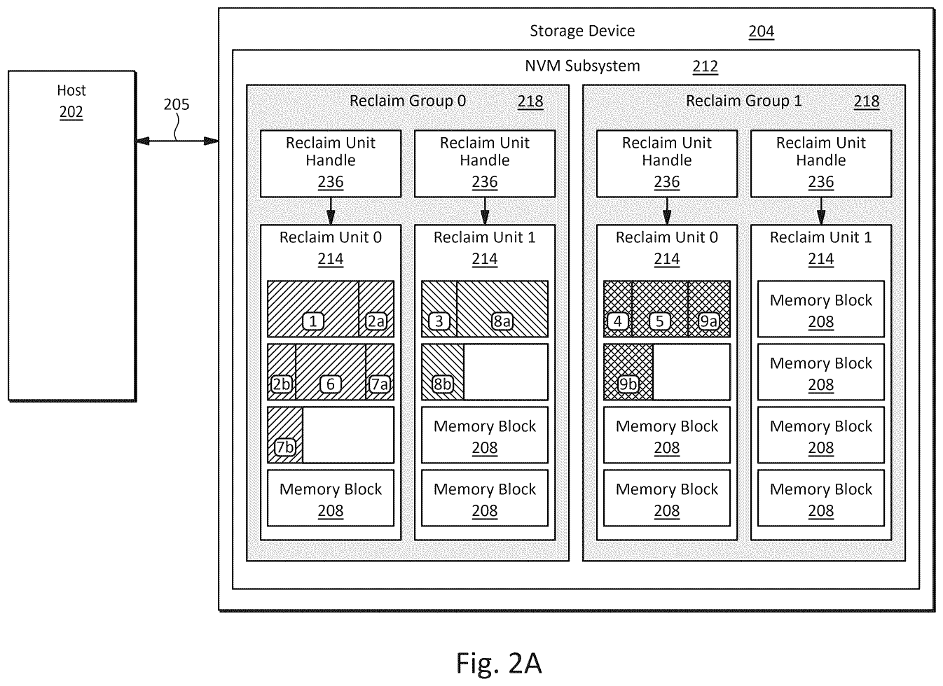

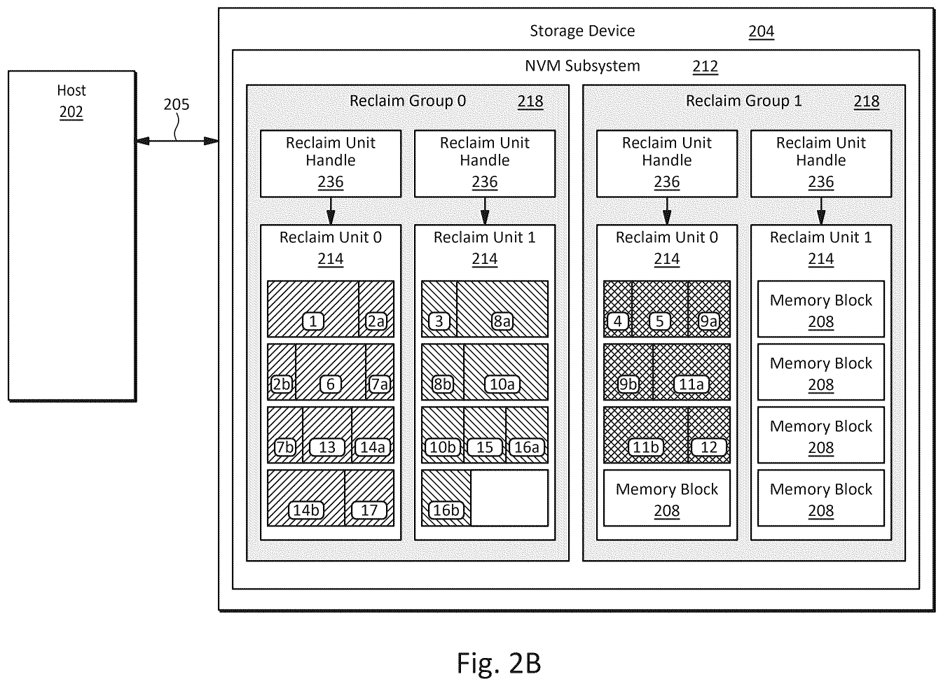

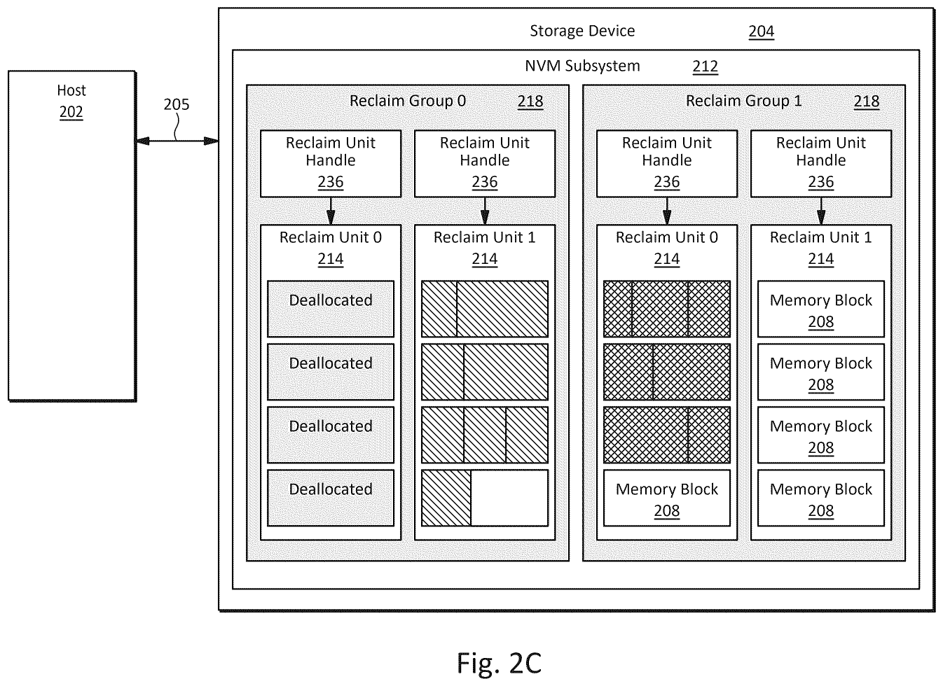

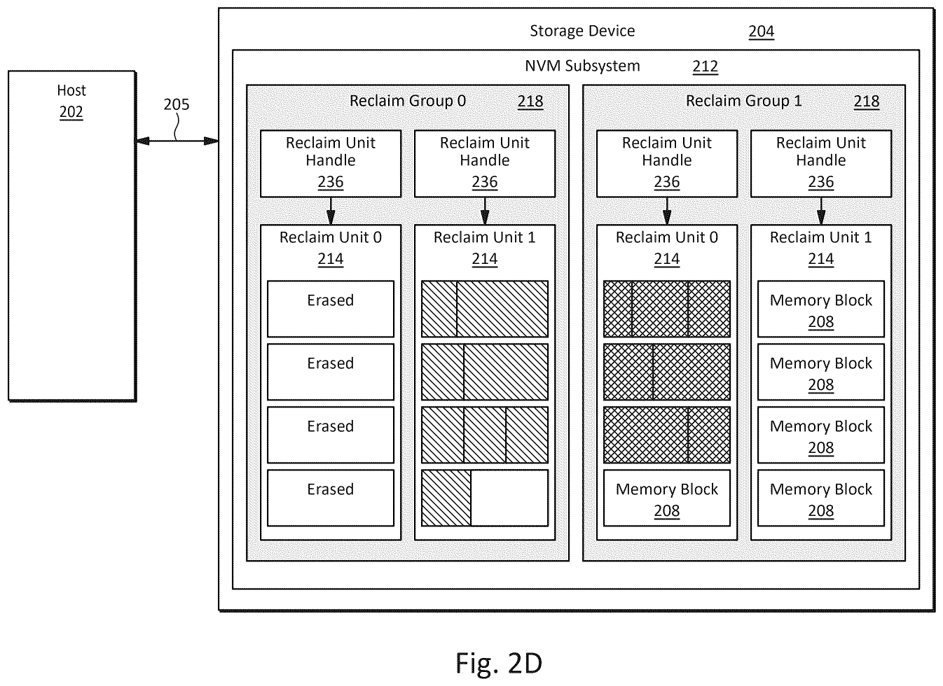

FIG. 2A illustrates an embodiment of an FDP scheme for a storage device in a first data placement state in accordance with example embodiments of the disclosure. FIG. 2B illustrates the embodiment of the data placement scheme illustrated in FIG. 2A in a second data placement state in accordance with example embodiments of the disclosure. FIG. 2C illustrates the embodiment of the data placement scheme illustrated in FIG. 2A in a third data placement state in accordance with example embodiments of the disclosure. FIG. 2D illustrates the embodiment of the data placement scheme illustrated in FIG. 2A in a fourth data placement state in accordance with example embodiments of the disclosure.

FIG. 2A, FIG. 2B, FIG. 2C, and/or FIG. 2D may be referred to collectively and/or individually as FIG. 2.

The embodiment illustrated in FIG. 2 may include some components such as a host 202, a storage device 204, a communication connection 205, and/or memory blocks 208 which, in some aspects, may operate in a manner similar to the corresponding components in the embodiment illustrated in FIG. 1. However, in the embodiment illustrated in FIG. 2, memory blocks 208 in the NVM subsystem 212 may be arranged in one or more RUs 214 that may be erased as a unit and may include one or more memory blocks 208. An RU 214 may be implemented, for example with one or more EBs, superblock, and/or the like. Moreover, the RUs 214 may be identified by corresponding RUHs 236 that may enable the host 202 to specify (e.g., in a field of a write command) a specific RU 214 to use for storing the write data associated with the write command. In some embodiments, some or all of the RUs 214 may be arranged in one or more RGs 218 which the host may also specify, for example, using one or more corresponding RG identifiers (e.g., in a field of a write command). In some embodiments, an RUH 236 may identify more than one RU 214. For example, an RUH 236 may identify (e.g., map to) one or more RUs 214 in one or more (e.g., each) RG 218 (e.g., in a manner similar to that illustrated in FIG. 4.)

Thus, by specifying specific RUs 214 and/or RGs 218 to use for storing data associated with write commands, the host 202 may cause the NVM subsystem 212 to only store data belonging to one or more specific namespaces in one or more RUs 214 and/or RGs 218.

For example, referring to FIG. 2A, the host 202 may instruct the NVM subsystem 212 to store data belonging to namespaces indicated by NSID 1, NSID 2, and NSID 3 in RU 0, RU 1, and RU 2, respectively, in the sequence indicated by the numbers in the rounded rectangles in FIG. 2 and indicated by the numbers in brackets as follows. For example, data [1] for a first write command associated with NSID 1 may be written to a first portion of the top memory block 208 of RU 0 of RG 0. A first portion of data [2a] for a second write command associated with NSID 1 may be written in the remaining portion of the top memory block 208 of RU 0 of RG 0, and a second portion of data [2b] for the second write command associated with NSID 1 may be written in a first portion of the second memory block 208 from the top of RU 0 of RG 0. Data [3] for a third write command associated with NSID 2 may be written to a first portion of the top memory block 208 of RU 1 of RG 0. Data [4] for a fourth write command associated with NSID 3 may be written to a first portion of the top memory block 208 of RU 0 of RG 1. Data [5] for a fifth write command associated with NSID 3 may be written to a next portion of the top memory block 208 of RU 0 of RG 1. Data [6] for a sixth write command associated with NSID 1 may be written to a next portion of the second memory block 208 from the top of RU 0 of RG 0. A first portion of data [7a] for a seventh write command associated with NSID 1 may be written in the remaining portion of the second memory block 208 from the top of RU 0 of RG 0, and a second portion of data [7b] for the seventh write command associated with NSID 1 may be written in a first portion of the third memory block 208 from the top of RU 0 of RG 0. A first portion of data [8a] for an eighth write command associated with NSID 2 may be written in the remaining portion of the top memory block 208 of RU 1 of RG 0, and a second portion of data [8b] for the eighth write command associated with NSID 2 may be written in a first portion of the second memory block 208 from the top of RU 1 of RG 0. A first portion of data [9a] for a ninth write command associated with NSID 3 may be written in the remaining portion of the top memory block 208 of RU 0 of RG 1, and a second portion of data [9b] for the ninth write command associated with NSID 3 may be written in a first portion of the second memory block 208 from the top of RU 0 of RG 1.

Referring to FIG. 2B, the host 202 may continue sending write commands and associated write data that it may instruct the NVM subsystem 212 to store in RUs corresponding to the respective namespaces using write commands in the sequence indicated by the numbers in the rounded rectangles which may correspond to data for the associated write commands.

Referring to FIG. 2C, the host may deallocate some or all of the data belonging to NSID 1 as shown by solid shading. For example, the data associated with any of the first, second, sixth, seventh, thirteenth, fourteenth, and/or seventeenth write commands may be deallocated at different times (with various amounts of time therebetween), in various combinations at different times, or all at once. Depending on the implementation details, this may enable the NVM subsystem 212 to erase RU 0 (as shown without shading in FIG. 2D) without moving data belonging to other namespaces, thereby reducing or eliminating write amplification. Although FIG. 2D may illustrate an RUH 236 referencing an RU 214 having one or more memory blocks 208 that may be erased, in some embodiments, one or more deallocated memory blocks 208 may be returned to a pool of available memory prior to being erased. Thus, in some embodiments, the memory blocks 208 indicated as being erased in FIG. 2D may not be the same memory blocks indicated as being deallocated in FIG. 2C but instead may be other memory blocks that may have previously been erased and arranged into a new (e.g., empty) RU 214. In some embodiments, in addition to namespaces, and/or as an alternative to namespaces, data may be divided and/or arranged into groups based on LBAs, one or more applications that may use the data, host write traffic threads, and/or the like, for separating and/or managing data based on RUHs, RUs, erase units, and/or the like.

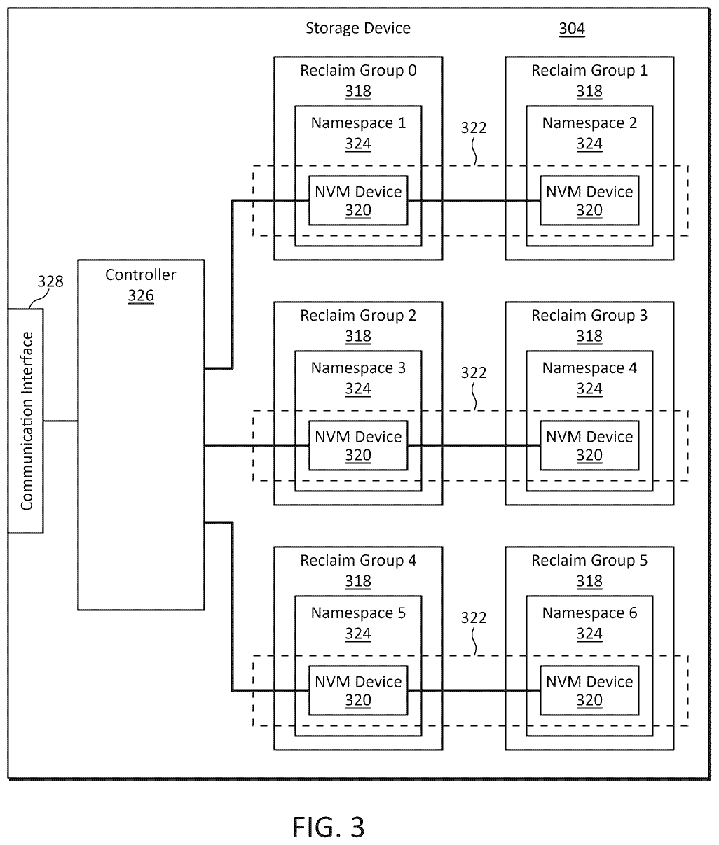

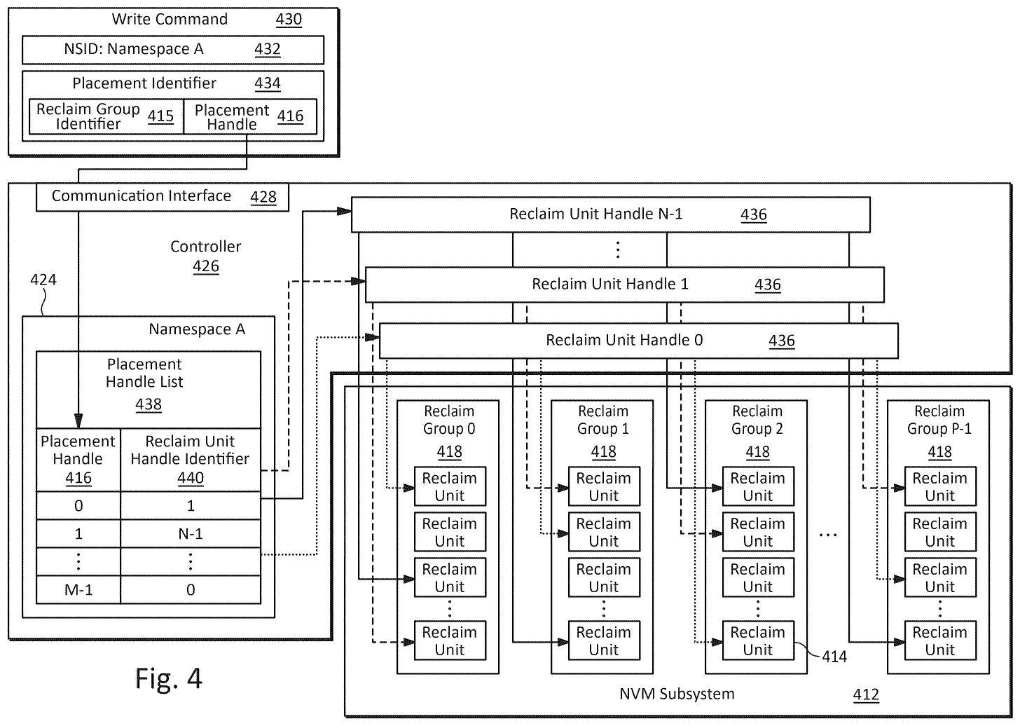

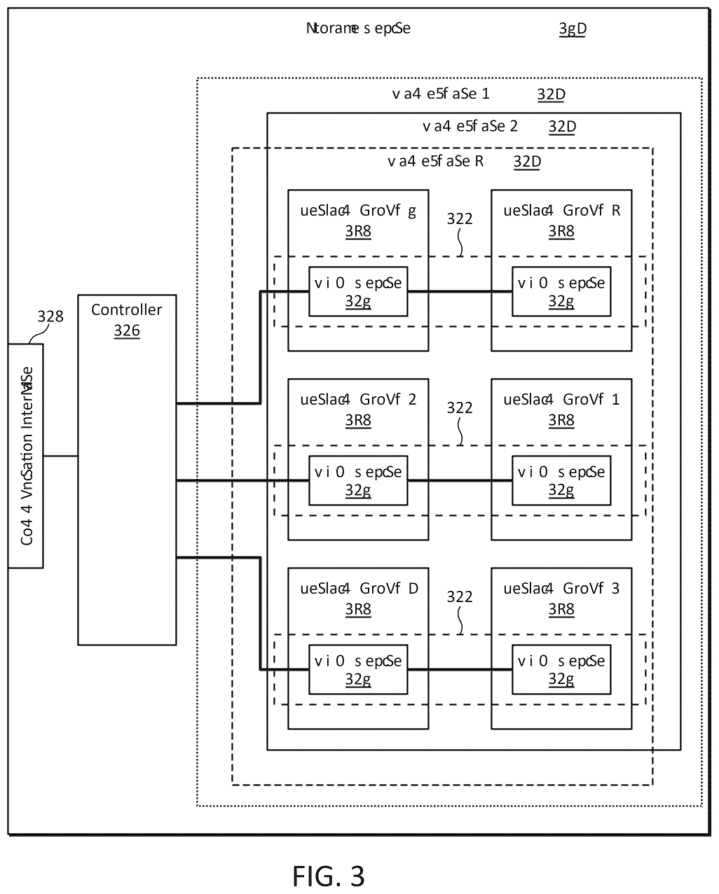

FIG. 3 illustrates an embodiment of an FDP scheme having namespaces corresponding to RGs in accordance with example embodiments of the disclosure.

Referring to FIG. 3, a storage device 304 may include storage media implemented with NVM devices (e.g., NVM dies) 320 arranged in one or more channels 322. The NVM devices 320 may be controlled by a storage device controller 326, which may also be referred to as a controller. The storage device 304 may communicate with a host using a communication interface 328.

The storage device 304 may implement an FDP scheme in which a host may specify an RG and/or RU to use for storing data associated with a write command sent from the host to the controller 326. In the embodiment illustrated in FIG. 3, one or more namespaces 324 may be associated with one or more NVM devices 320 (e.g., each namespace 324 may be associated with a corresponding NVM device 320). One or more RGs 318 may be associated with one or more namespaces 324 (e.g., each RG 318 may be associated with a corresponding namespace 324). In some implementations, an RG 318 may be implemented with one or more RUs as shown, for example, in the embodiment illustrated in FIG. 2. In some implementations, an RU 324 may be implemented with two EBs, for example, one EB per plane on a two-plane NVM device 320.

Depending on the implementation details, the embodiment illustrated in FIG. 3 may enable a host to spread write data across the channels 322 in any manner that it may decide. For example, a host may write data to multiple RGs 318 concurrently to improve write BW. As another example, a host (e.g., using application data) and/or an application, processes, and/or the like running on a host, may place data that may be deallocated together (e.g., because of being similarly aged, associated with the same application, and/or the like) in one or more common namespaces 324, RGs 318, and/or the like. As a further example, a host (e.g., using application data) and/or an application, processes, and/or the like running on a host, may place data in the namespaces 324, RGs 318, and/or the like in such a manner as to improve read BW and/or QoS.

FIG. 4 illustrates an embodiment of an FDP scheme having RUHs in accordance with example embodiments of the disclosure. The embodiment illustrated in FIG. 4 may include a controller 426 and an NVM subsystem 412. The NVM subsystem 412 may include P RGs 418 identified as RG 0 through RG P−1. AN RG 418 may include one or more RUs 414.

The controller 426 may receive I/O commands 430 from a host through a communication interface 428. An I/O command 430, which in the example illustrated in FIG. 4 may be a write command, may include an NSID 432 and/or a placement identifier 434. The placement identifier 434 may include an RG identifier 415 and/or a placement handle 416 that may enable a host to specify an RG 418 and/or an RU 414, respectively, within the RG 418 to use to store data associated with the write command 430. Thus, in some embodiments, the scheme illustrated in FIG. 4 may enable a host to align data that may be deallocated together (e.g., data belonging to a namespace) with one or more RUs 414 that may be erased as units.

In some embodiments, a placement handle 416 may map to an RUH (RUH) 436 that may reference one or more RUs 414 in one or more RGs 418 (e.g., an RUH may map to one RU 414 in each RG 418 as shown in the example mappings illustrated in FIG. 4). In the embodiment illustrated in FIG. 4, the controller may use N RUHs 436 identified as RUH 0 through RUH N-1. In some embodiments, the RUHs 436 may be characterized as a controller resource.

The controller 426 may use a placement handle list 438 to map one or more placement handles 416 to one or more RUH identifiers (RUH IDs) 440, which in turn may identify a corresponding RUH 436. In the embodiment illustrated in FIG. 4, the placement handle list 438 may include M placement handles identified as Placement Handle 0 through Placement Handle M−1.

In some embodiments, a placement handle 416 may be scoped to a namespace 424 (in this example, a namespace identified as Namespace A). The namespace may, in turn, encompass one or more (e.g., all) RUs 414 referenced by the one or more RUHs 436 identified in the placement handle list 438 (e.g., by RUH IDs 440). In some embodiments, the placement handle list 438 may be created, populated, revised, maintained, and/or the like, by a host, a storage device (e.g., the controller 426), or any other entity or combination thereof.

In some embodiments, the use of the placement handles 416 and/or RUHs 436 may enable the FDP scheme illustrated in FIG. 4 to present an RU to a host as a logical representation of physical nonvolatile storage within an RG that may be physically erased by the controller 426, for example, without disturbing other RUs 414. The controller 426 may implement a logical RU specified by a host (e.g., using a placement identifier 434) with physical storage media (e.g., one or more EBs on an NVM die) that may be selected by the controller 426 and erased as a unit.

In some embodiments, the selection of an RU 414 and/or RG 418 may be performed, at least partially, by the controller 426. For example, if the controller 426 receives a write command 430 that does not indicate a placement identifier 434, the controller may use an RUH 436 mapped by a default placement handle 416 (e.g., Placement Handle 0) and select an RG 418, thereby selecting the RU 414 that is within the selected RG 418 and referenced by the RUH 436 mapped by the default placement handle 416. As another example, if the controller 426 receives a write command 430 with a placement identifier that includes a placement handle 416 but not an RG identifier 415, the controller 426 may select an RU 414 by selecting an RG 418 and using the RU 414 that is within the selected RG 418 and referenced by the RUH 436 mapped by the placement handle 416 provided with the write command 430.

In some embodiments, the FDP scheme illustrated in FIG. 4 may be implemented at least partially using an NVMe protocol. In such an embodiment, placement identifier 434 may be implemented as a portion of the command 430 (e.g., a directive portion of an NVMe command); M, N, and/or P may be parameters that may be configured, for example, using an NVMe Namespace Management command; the controller 426 may be implemented with one or more NVMe controllers; and/or the NVM subsystem 412 may be implemented as an NVMe subsystem, an endurance group (which, in some embodiments may be coextensive with a storage device), an NVMe domain, and/or the like, or any combination thereof. In an embodiment implemented at least partially using an NVMe protocol, a directive specific (DSPEC) field may be used to provide a placement identifier (e.g., an RG (which may be indicated by an RG identifier) and a placement handle). A DSPEC field may be used, for example, in an implementation in which a directive type (DTYPE) field may be used to indicate that an FDP feature is used. In such an embodiment, an invalid and/or default (e.g., all zeros) value of a DSPEC field may indicate the absence of an RG indicator and/or placement handle.

In the embodiments of FDP schemes illustrated in FIG. 2, FIG. 3, and/or FIG. 4, an RU may be implemented (at least from the perspective of a host) as a logical representation of an underlying portion of physical storage media. Thus, the host may be shielded from, and/or not aware of, one or more ongoing operations and/or conditions of the storage device that may adversely affect one or more operations involving a physical implementation of a logical RU selected by the host.

For example, in the embodiment illustrated in FIG. 4, a host may send a write command 430 with a placement identifier 434 including an RG identifier 415 and a placement handle 416 that may specify a specific RU 414 for storing data associated with the write command. However, the controller 426 may have implemented the specified RU 414 with physical storage media (e.g., an NVM die) that may be busy with a read operation. Thus, the write operation requested by write command 430 may be delayed until the read operation is completed.

Other examples of ongoing operations and/or conditions of the storage device that may be unknown to a host and may adversely affect one or more operations involving a physical implementation of a logical RU selected by the host may include: NVM die management conflicts; programming operations involving programming data from a write buffer in a controller into an RU selected by the host; erase operations being conducted by a die containing an RU selected by the host; GC operations involving an RU selected by the host; and/or the like. As another example, an RG may not have adequate available space in the RUs in the RG (e.g., the available RUs in the RG may already contain too much host user data in this NVM), for example, because of losing one or more EBs due to end of life (EOL) and/or error conditions.

To the extent a host may gain an awareness of one or more operations of the physical storage media underlying the FDP scheme illustrated in FIG. 4 by observing the behavior (e.g., NVM die programming delays, erasure delays, and/or the like), the host's awareness may be delayed, for example, due to NVM channel delays, controller delay, communication connection delay (e.g., PCIe delay), host central processing unit (CPU) delay, and/or the like.

In an FDP scheme in accordance with example embodiments of the disclosure, a storage device to select an RU and/or RG (e.g., to use for storing data associated with a write request) based on one or more operations and/or conditions of the storage device.

For example, as described above, in some cases (e.g., when a controller 426 receives a write command 430 that does not include a placement handle 416 or includes a placement handle 416 but not an RG identifier 415) a controller 426 may select an RU 414 and/or RG 418 to use for storing data associated with a write command. In such a case, the controller 426 may base the selection of the RU 414 and/or RG 418, at least partially, on one or more operations of the storage device that may affect the performance of a write operation associated with the write command. For example, the controller 426 may select an RU 414 and/or RG 418 that is implemented with physical storage media (e.g., an NVM die) that is not currently busy with a program (e.g., write) operation, a read operation, an erase operation, a GC operation, and/or the like. As another example, the controller 426 may select an RU 414 and/or RG 418 having a command queue with no or relatively few pending commands. As a further example, a controller may select an RU 414 and/or RG 418 based on an opportunistic status such as an NVM die that is approaching the completion of a programming cycle, an associated write buffer that is nearing a full word line, and/or an open block timer that is nearing expiration.

Additionally, or alternatively, the controller 426 may base the selection of the RU 414 and/or RG 418, at least partially, on one or more conditions of the storage device that may affect the performance of a write operation associated with the write command. For example, the controller 426 may avoid selecting an RU and/or RG in which an NVM die may be exhibiting end-of-life (EOL) behavior such as relatively low operation speed, relatively high bit error accumulation rate, voltage shifts, and/or the like. Additionally, or alternatively, the controller 426 may select an RU and/or RG in which the physical storage media may exhibit relatively young behavior.

In some embodiments, an operation of a storage device may refer to an ongoing operation such as a read, write, and/or erase operation that is currently being performed, a command queue that currently contains a relatively large number of commands, a write buffer that is currently nearing a full word line, and/or the like. In some embodiments, an ongoing operation may be in contrast to a previous operation such as a previous selection of an RU based on a round-robin technique or a wear leveling technique. In some embodiments, a wear leveling technique may manage the behavior of the NVM to attempt to equalize (at least approximately equalize) the number of program and/or erase (P/E) cycles on one or more (e.g., each) EB of the NVM. In some embodiments, one or more modifiers may alter the attempt to equalize the P/E cycles, for example, based on one or more ongoing behaviors and/or conditions of the NVM (e.g., fewer P/E cycles may be performed on an EB that may already have indications of relatively higher wear.

FIG. 5 illustrates another embodiment of an FDP scheme in accordance with example embodiments of the disclosure.

Referring to FIG. 5, a storage device 504 may include storage media implemented with NVM devices (e.g., NVM dies) 520 arranged in one or more channels 522. The NVM devices 520 may be controlled by a controller 526. The storage device 504 may communicate with a host using a communication interface 528.

The storage device 504 may implement an FDP scheme in which a host may specify an RG and/or RU to use for storing data associated with a write command sent from the host to the controller 526. In a manner similar to the embodiment illustrated in FIG. 3, one or more RGs 518 may be associated with one or more NVM devices 520 (e.g., each RG 518 may be associated with a corresponding NVM device 520). However, in the embodiment illustrated in FIG. 5, one or more namespaces (e.g., Namespace 1, Namespace 2, and/or Namespace 3) may encompass at least a portion of more than one RG 518. In some embodiments, in addition to namespaces, and/or as an alternative to namespaces, data may be divided and/or arrange data associated with the write command into groups based on LBAs, one or more applications that may use the data, host write traffic threads, and/or the like, for separating and/or managing data based on RUHs, RUs, erase units, and/or the like.

For example, in some embodiments, a namespace 524 may encompass at least a portion of each RG 518. However one namespace 524 (e.g., Namespace 1) may be separate from other namespaces (e.g., Namespace 2, and/or Namespace 3) based on one or more RUs and/or RUHs. For example, if the embodiment illustrated in FIG. 5 is implemented using the RUH scheme illustrated in FIG. 4, one or more RUHs associated with a second namespace (e.g., a Namespace B) may reference only RUs 414 that may not be referenced by any of the RUHs 436 associated with Namespace A.

In some embodiments, an RUH (e.g., specified by a host) that is specific to a namespace may be resolved by the controller 526 to more than one RUH across multiple RGs 518. For example, an RUH (RUH 0) associated with a namespace NSID 1 may translate to an allowed RUH (RUH A) in an RG (RG 0), RUH B in RG1, . . . , and/or RUH F in RG5, where RUH A through RUH F may be unique RUH IDs within the storage device 504. In some embodiments, a host may configure the one or more namespaces 524 to have unique RUHs on one or more (e.g., each) RG 518. Alternatively, or additionally, a host may share one or more RUHs between two or more namespaces 524.

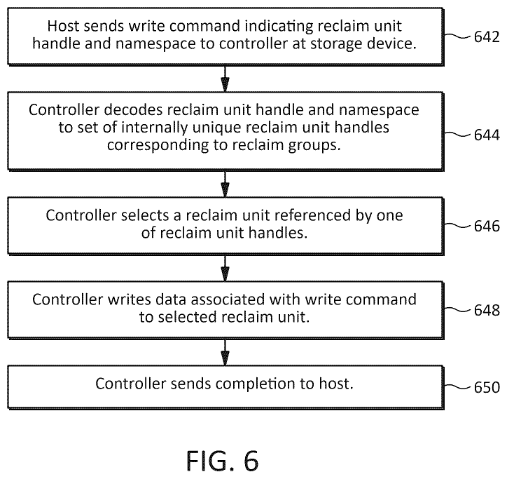

FIG. 6 illustrates an embodiment of a method for servicing a write command using an FDP scheme in accordance with example embodiments of the disclosure. The method illustrated in FIG. 6 may be implemented, for example, using the storage device 504 illustrated in FIG. 5, however, the inventive principles are not limited to these or any other implementation details.

Referring to FIG. 6, the method may begin at operation 642 where a host may send a write command indicating an RUH and a namespace (e.g., RUH A and NSID 1) to a controller at a storage device. At operation 644, the controller may decode the RUH and namespace to an acceptable set of corresponding internally unique RUHs (e.g., RUH A, RUH B, . . . , RUH F) corresponding to RGs (e.g., RG 0, RG 1, . . . , RG 5, respectively) that may be used to store data associated with the write command. At operation 646, the controller may select an RU referenced by one of the RUHs. In some embodiments, the selection may be based on one or more operations and/or conditions of the storage device. At operation 648, the controller may write the data associated with the write command to the selected RU. At operation 650, the controller may send a completion to the host. In some embodiments, the write operation 648 may be performed as a background task in parallel with operation 650. In some embodiments, in addition to namespaces, and/or as an alternative to namespaces, a host may divide and/or arrange data associated with the write command into groups based on LBAs, one or more applications that may use the data, host write traffic threads, etc., for separating and/or managing data based on RUHs, RUs, erase units, and/or the like.

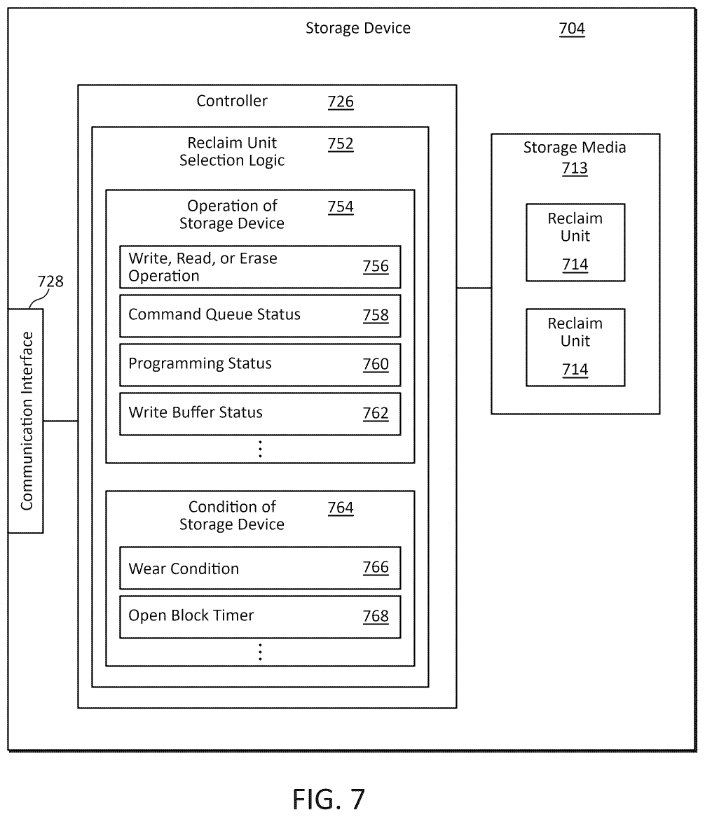

FIG. 7 illustrates an embodiment of a storage device with FDP in accordance with example embodiments of the disclosure. The storage device 704 illustrated in FIG. 7 may include storage media 713 and a controller 726. The storage media 713 may include two or more RUs 714. In some embodiments, some or all of the RUs 714 may be arranged in RGs. The controller 726 may include RU selection logic 752 (which may also be referred to as selection logic) that may select one or more of the RUs 714 to be used to store data associated with a write command that may be received, for example, using a communication interface 728.

In some embodiments, the selection logic 752 may select one or more of the RUs 714 based, at least in part, on RUH that may be indicated by a write command (e.g., using a placement identifier that may include an RG identifier and/or a placement handle). In some embodiments, the selection logic 752 may select one or more of the RUs 714 based, at least in part, on an operation and/or condition of the storage device 704 using logic 754 and/or 764.

Logic 754 may include logic that may enable the controller 726 to select one or more of the RUs 714 based, at least in part, on an operation of the storage device 704. For example, logic 754 may include one or more of various types of logic including logic 756, 758, 760, 762, and/or the like. Logic 756 may select an RU 714 based on the current status of a write operation, read operation, erase operation, and/or the like. For example, the logic 756 may select an RU 714 that may include physical storage media (e.g., an NVM die) that is not currently busy, or may not soon be busy, with a write operation (e.g., a program operation), a read operation, an erase operation, and/or the like.

Logic 758 may select an RU 714 based on the status of one or more command queues associated with the RU. For example, the logic 758 may avoid selecting an RU 714 for which a command queue in the controller 726 has any pending commands (or a relatively large number of commands), for example, because the RU 714 may not be able to service the write command until its corresponding command queue is cleared.

Logic 760 may select an RU 714 based on the programming status of physical storage media (e.g., an NVM die) with which the RU 714 may be implemented. In some embodiments, this may be implemented as an opportunistic determination. For example, logic 760 may select an RU having physical storage media that is currently being programmed (e.g., written) if the programming segment is nearing completion. Depending on the implementation details, this may enable write data to be programmed into the RU 714 immediately or shortly after the current programming segment is completed.

Logic 762 may select an RU 714 based on the status of a write buffer associated with the RU 714, for example, whether the write buffer is nearing a full word line (e.g. for a specific RG).

Additionally, or alternatively, logic 764 may include logic that may enable the controller 726 to select one or more of the RUs 714 based, at least in part, on a condition of the storage device 704. For example, logic 764 may include one or more of various types of logic including logic 766, 768, and/or the like. Logic 766 may select an RU 714 based on the condition (e.g. wear condition) of physical storage media (e.g., an NVM die) that is used to implement the RU 714. For example, the logic 766 may observe one or more behaviors of an NVM die to determine if it is approaching EOL. Behaviors the logic 766 may observe may include program speed, read speed, erase speed, and/or the like, bit error accumulation rate, one or more sense voltage shifts, behaviors as a function of temperature, and/or the like. In some embodiments, the logic 766 may emphasize selecting one or more RUs 714 that exhibit relatively young (e.g., low wear) behavior for programming with write data to achieve relatively even wear of different RUs, to provide better performance for the write data, and/or the like.

Logic 768 may select an RU 714 based on the status of an open block timer for physical storage media used to implement the RU 714. For example, if an open block timer for an RU 714 is nearing expiration, the logic 768 may preferentially select that RU to prevent the timer from closing out the block with a lower usage percentage. Depending on the implementation details, this may improve the overall storage media utilization, capacity, and/or the like.

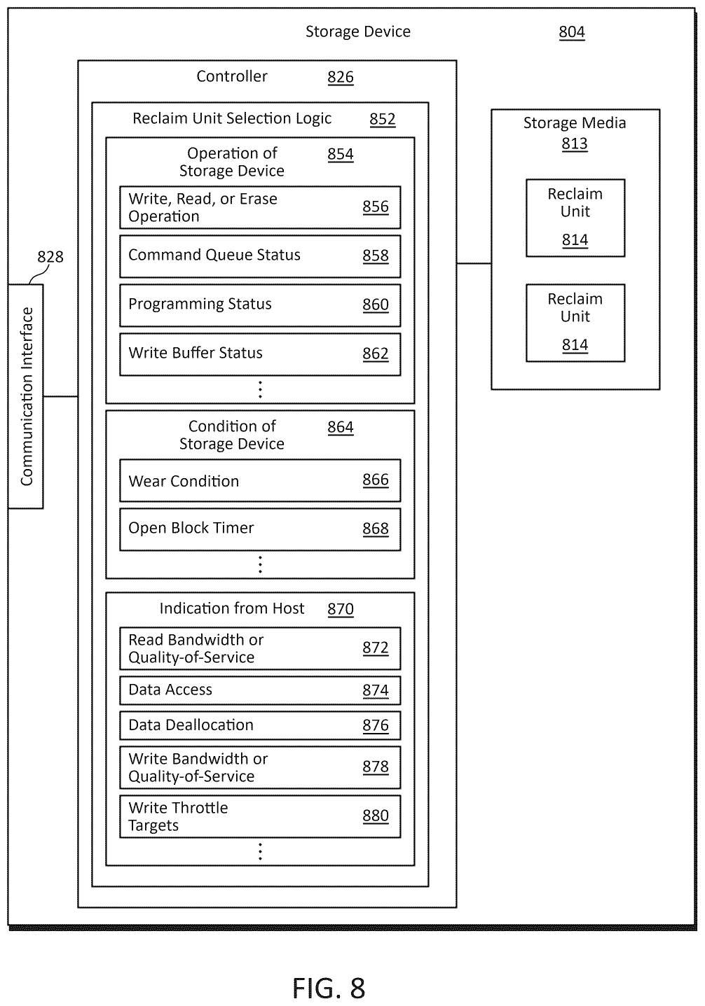

FIG. 8 illustrates another embodiment of a storage device with FDP in accordance with example embodiments of the disclosure.

Referring to FIG. 8, the storage device 804 may include one or more components that, in some aspects, may be similar to those in the embodiment illustrated in FIG. 7 with similar components indicated with reference numbers ending in the same digits. For example, logic 826, 852, 854, 856, 858, 860, 862, 864, 866, and 868 may operate similar to logic 726, 752, 754, 756, 758, 760, 762, 764, 766, and 768 as described above with reference to FIG. 7. However, the embodiment illustrated in FIG. 8, may additionally, or alternatively, include logic 870 that may select one or more of the RUs 714 based, at least in part, on one or more indications provided by a host. For example, logic 870 may include one or more of various types of logic including logic 872, 874, 876, 878, 880, and/or the like. Logic 872 may select an RU 814 based on its ability to enhance (e.g., optimize) read QoS and/or read BW for data stored in the RU 814. For example, logic 872 may select an RU 814 based on its ability to enhance read QoS by distributing data in write units (e.g., 4 KB write units) across one or more die. As another example, logic 872 may select an RU 814 based on its ability to enhance read BW by distributing data in word lines (e.g., full word lines) across one or more die.

Logic 874 may select one or more RUs 814 based on one or more data access patterns (e.g., whether write data associated with a write command is hot or cold data). For example, relatively cold data may be placed in an RU 814 having EBs that may behave as they are relatively old and/or have a high level of wear. In some embodiments, this may be implemented with one or more unique RUHs being duplicated in a RG. For instance, one RUH in an RG may reference an older behaving RU, and another RUH in the RG may reference a younger behaving RU (e.g., an RU that may have performed relatively few program and/or erase (P/E) cycles).

Logic 876 may select one or more RUs 814 based on one or more data deallocation patterns. For example, data that is likely to be deallocated together may be written to the same RU and/or RG (e.g., without further spreading of the data).

Logic 878 may select one or more RUs 814 to enhance (e.g., optimize) write BW and/or QoS. For example, RUs 814 may be selected with one RUH per RG to write data in word line (e.g., full word line) units.

Logic 880 may select one or more RUs 814 to accommodate one or more write throttle targets. For example, a host may attempt to limit the number of RUHs on one or more RGs to meet one or more BW limits that may be smaller than the total number of RGs that may be available (e.g., for maximum BW).

Each of the various logic components illustrated in FIG. 7 and FIG. 8 may have independent utility and may be implemented separately without any of the other logic components. Thus, some embodiments may omit one or more of the logic components or include other logic components. In some embodiments, various combinations of the logic components may provide synergistic results.

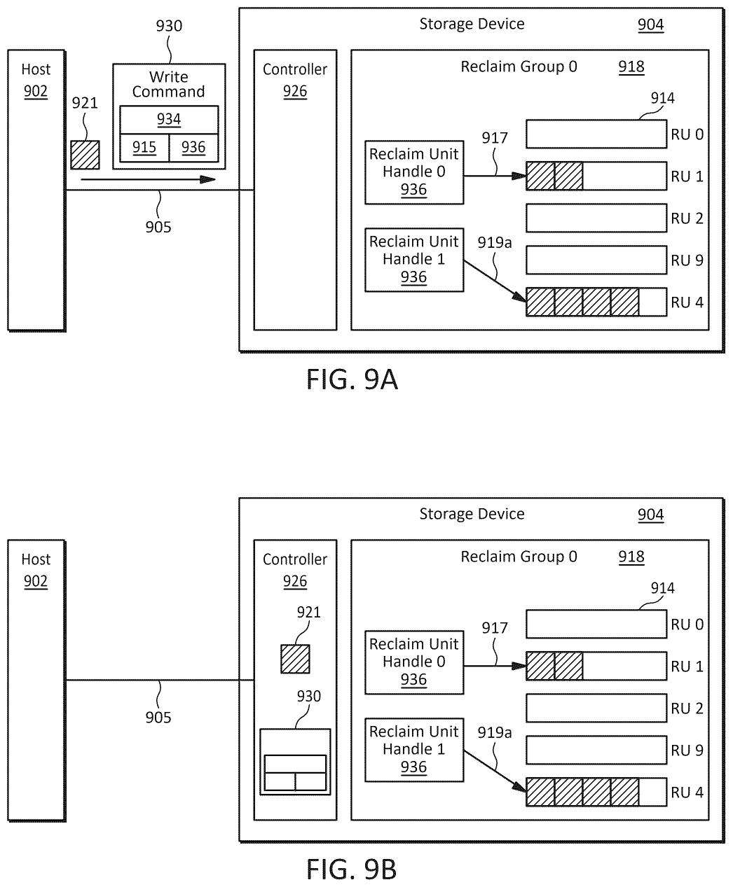

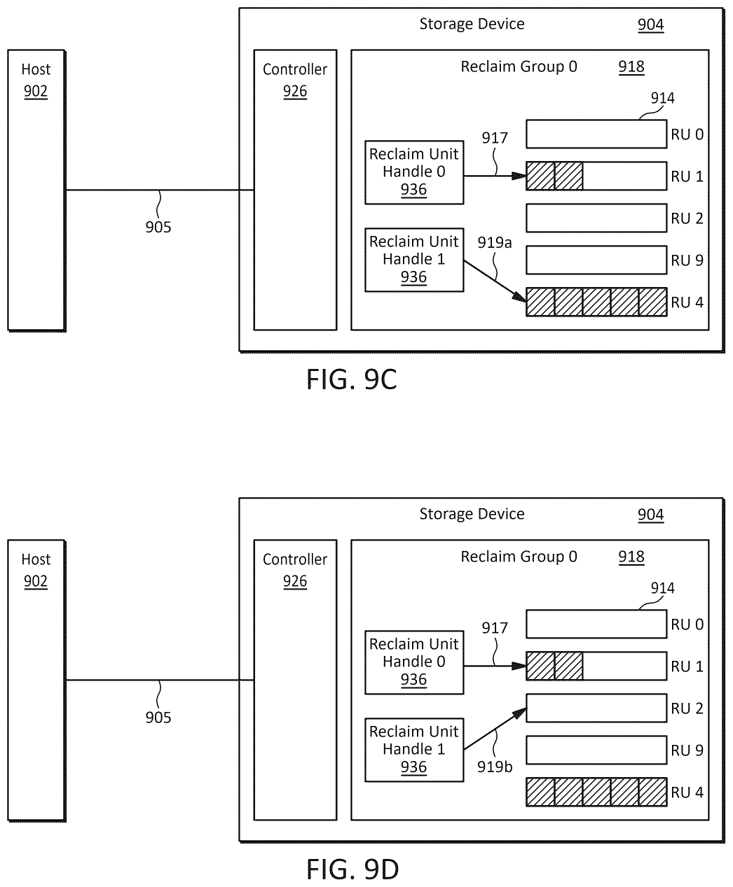

FIG. 9A illustrates an embodiment of an FDP scheme with reference modification in a first data placement state in accordance with example embodiments of the disclosure. FIG. 9B illustrates the embodiment of the data placement scheme illustrated in FIG. 9A in a second data placement state in accordance with example embodiments of the disclosure. FIG. 9C illustrates the embodiment of the data placement scheme illustrated in FIG. 9A in a third data placement state in accordance with example embodiments of the disclosure. FIG. 9D illustrates the embodiment of the data placement scheme illustrated in FIG. 9A in a fourth data placement state in accordance with example embodiments of the disclosure.

FIG. 9A, FIG. 9B, FIG. 9C, and/or FIG. 9D may be referred to collectively and/or individually as FIG. 9.

The embodiment illustrated in FIG. 9 may include a host 902 and a storage device 904 communicating using a communication connection 905. The storage device 904 may include a controller 926 (which may control the overall operation of the storage device 904) and storage media including RUs 914 arranged in one or more RGs 918. One RG 918 referred to as RG 0 is illustrated in FIG. 9, but the RUs 914 may be arranged in any number of RGs 918. For purposes of illustration, in the embodiment illustrated in FIG. 9, RG 0 may include five RUs 914 identified as RU 0, RU 1, RU 2, RU 3, and RU 4, each of which may have a storage capacity of five pages of data, but any number and/or size of RUs may be used. For example, in a practical implementation, an RU may include one, two, four, or more EBs, each of which may have a storage capacity measured in MB or GB and page size measured in KB.

One or more RUHs 936 may reference corresponding RUs 914. For example, as shown in FIG. 9A, a first RUH 936 identified as RUH 0 (or RUH 0) may reference RU 1 as indicated by arrow 917. A second RUH 936 identified as RUH 1 (RUH 1) may reference RU 4 as indicated by arrow 919a.

Referring to FIG. 9A, the storage device 904 may be shown in an initial state in which two pages of data may be stored in the RU 914 identified as RU 1, and four pages of data may be stored in the RU 914 identified as RU 4 as shown by the diagonally shaded portions of RU 1 and RU 4.

The host 902 may send a write command 930 and a page of data 921 (or an address, pointer, or other indicator of a location of the page of data 921) to the storage device 904 using communication connection 905. The command 930 may include a placement identifier 934 that may include an RG identifier 915 and/or RUH 936. In the example illustrated in FIG. 9, the RG identifier 915 and RUH 936 may instruct the storage device 904 to store the page of data 921 at the RU 914 referenced by RUH 1 in RG 0.

In some embodiments, the command 930 and/or the placement identifier 934 may use a different technique to specify an RU into which the data 921 is to be written. For example, rather than directly provide an RUH 936, the command 930 and/or placement identifier 934 may include a placement handle that may specify an RUH, for example, as illustrated in the embodiment described with respect to FIG. 4.

Referring to FIG. 9B, the controller 926 may receive the write command 930 and/or page of data 921. Based on the RG identifier 915 and RUH 936 in the placement identifier 934 included in the write command 930, the controller 926 may determine that the page of data 921 should be stored in the RU 914 referenced by RUH 1 in RG 0. In the example illustrated in FIG. 9B, RUH 1 may reference the RU 914 identifies as RU 4, and thus, the controller 926 may store the page of data 921 in RU 4 as shown in FIG. 9C.

Referring to FIG. 9D, the page of data 921 may have filled the RU 914 indicated as RU 4 as shown with diagonal shading. Thus, the controller 926 may modify the RUH 1 to reference a different (e.g., empty) RU 914 within RG 0 such as RU 2 as shown by arrow 919b. The controller 926 may then proceed to fill RU 2 with data received from the host using write commands 930 that specify RUH 1 in the placement identifier 934.

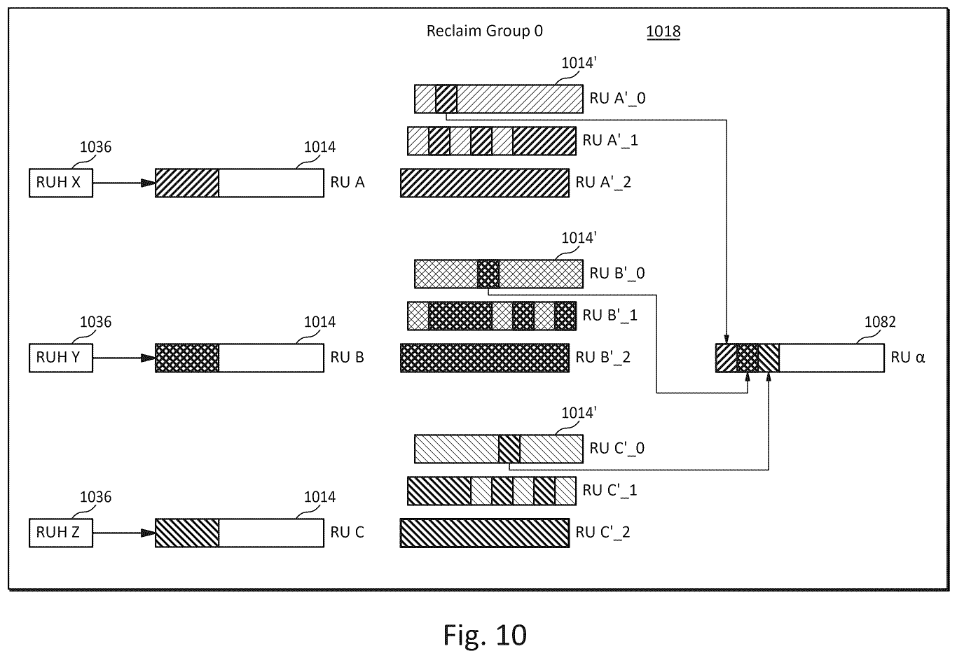

FIG. 10 illustrates an embodiment of an initial isolation scheme for an FDP scheme for a storage device in accordance with example embodiments of the disclosure. The embodiment illustrated in FIG. 10 may include three RUHs 1036 identified as RUH X, RUH Y, and RUH Z.

The RUH X may currently reference an RU 1014 identified as RU A. The RU A may be partially filled with data as shown with single diagonal shading with lines running from top right to bottom left. The RUH X may have previously referenced RUs 1014′ identified as RU A′_0, RU A′_1, and RU A′_2. The previously referenced RUs 1014′ may have been filled with data (as shown with single diagonal shading with lines running from top right to bottom left), for example, when they were referenced by RUH X in a manner similar to the way the RU 914 identified as RU 4 was filled with data when it was referenced by RUH 1 as illustrated in FIG. 9B and FIG. 9C. Although not currently referenced by RUH X, the previously referenced RUs RU A′_0, RU A′_1, and RU A′_2 may still remain associated with RUH X, for example, by using a data structure such as an RU association table.

The RUH Y may currently reference an RU 1014 identified as RU B. The RU B may be partially filled with data as shown with diagonal cross shading. The RUH Y may have previously referenced RUs 1014′ identified as RU B′_0, RU B′_1, and RU B′_2. The previously referenced RUs 1014′ may have been filled with data (as shown with diagonal cross shading), for example, when they were referenced by RUH Y.

Likewise, the RUH Z may currently reference an RU 1014 identified as RU C. The RU C may be partially filled with data as shown with single diagonal shading with lines running from top left to bottom right. The RUH Z may have previously referenced RUs 1014′ identified as RU C′_0, RU C′_1, and RU C′_2. The previously referenced RUs 1014′ may have been filled with data (as shown with single diagonal shading with lines running from top left to bottom right), for example, when they were referenced by RUH Z.

In some embodiments, a controller within a storage device may perform one or more operations (e.g., maintenance operations) on data stored in previously referenced RUs 1014′. For example, some or all of the data stored in the previously referenced RUs 1014′ may be deallocated (e.g., by a host), thereby resulting in unused storage capacity in the previously referenced RUs 1014′. This is illustrated in FIG. 10 in which the portions of the previously referenced RUs 1014′ containing deallocated (e.g., invalid) data are shown with shading having relatively thinner lines.

In some embodiments, a controller may perform one or more maintenance operations to enable the unused storage capacity in the previously referenced RUs 1014′ to be erased, reused, repurposed, and/or the like. For example, a controller may perform a GC operation in which valid data (e.g., data that has not been deallocated) in one or more of the previously referenced RUs 1014′ may be copied to a different RU so the one or more of the previously referenced RUs 1014′ may be erased and reused.

The embodiment illustrated in FIG. 10 may implement an initial isolation scheme in which data written to RUs that are currently, or were previously, referenced by different RUHs 1036 may be initially isolated from each other. (In some embodiments, data may be considered isolated if the RU in which it is stored only includes data that was written to the RU using the same RUH.) Thus, RUs RU A, RU A′_0, RU A′_1, and RU A′_2 may only include data that was written when these RUs were referenced by RUH X. Similarly, RUs RU B, RU B′_0, RU B′_1, and RU B′_2 may only include data that was written when these RUs were referenced by RUH Y, and RUs RU C. RU C′_0, RU C′_1, and RU C′_2 may only include data that was written when these RUs were referenced by RUH Z.

However, as part of a controller operation, data from RUs that were written using different RUHs may be combined in a single RU. This is illustrated in FIG. 10 in which a controller may read valid data from previously referenced RUs RU A′_0, RU B′_0, and RU C′_0 and write them to an RU 1082 identified as RU α. Because the valid data copied from the previously referenced RUs RU A′_0, RU B′_0, and RU C′_0 may be the last remaining valid data in one or more of these RUs, one or more of the RUs RU A′_0, RU B′_0, and/or RU C′_0 may be erased, e.g., as part of a GC operation to be reused for storing other data. An RU that has been erased (e.g., garbage collected) may be removed from an RU association table that it may have been listed in.

In some embodiments, the isolation scheme illustrated in FIG. 10 may be referred to as an initial isolation scheme because data written using different RUHs 1036 may be initially isolated in different RUs, but may eventually be combined, e.g., by a subsequent operation such as a GC operation, a media management operation (e.g., refresh program, read disturb), and/or the like. In some embodiments, the isolation scheme illustrated in FIG. 10 may be referred to as a host isolation scheme because the host may determine (e.g., using RUHs) the placement of data in isolated RUs.

TABLE 1
RU Association Table

| RUH X | RUH Y | RUH Z |
|---|---|---|
| RU A′_0 | RU B′_0 | RU C′_0 |
| RU A′_1 | RU B′_1 | RU C′_1 |
| RU A′_2 | RU B′_2 | RU C′_2 |
| . . . | . . . | . . . |

Although one RG 1018 is illustrated in FIG. 10, the RUs 1014 may be arranged in any number of RGs. In some embodiments, data from RUs in different RGs (e.g., valid data from previously referenced RUs in different RGs) may be combined in the same RU.

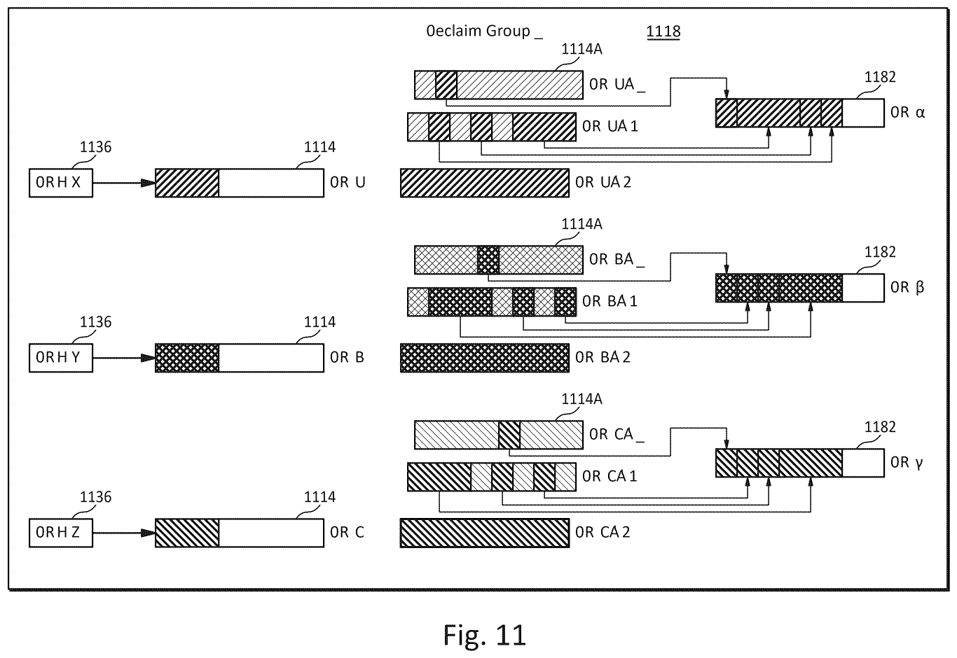

FIG. 11 illustrates an embodiment of a persistent isolation scheme for an FDP scheme for a storage device in accordance with example embodiments of the disclosure. The embodiment illustrated in FIG. 11 may include three RUHs 1136 identified as RUH X. RUH Y, and RUH Z that may be used to write data to currently referenced RUs 1114 and/or previously referenced RUs 1114′ in a manner similar to that described above with respect to FIG. 10.

However, contrary to an initially isolated scheme as in FIG. 10, wherein data segregation is guaranteed at a host write, but not throughout the life of the data, e.g., a subsequent GC process can intermix this data with those from the other RUHs, in a persistent isolation scheme as in FIG. 11, data's segregation from those of the other RUH's is guaranteed for the life of the data. Accordingly, the isolation scheme illustrated in FIG. 11 may involve more isolation of data that was written using different RUHs compared to the embodiment described above with respect to FIG. 10. For example, in the embodiment illustrated in FIG. 11, in a controller operation that may move data from previously referenced RUs 1114′, data that was written using different RUHs may not be combined in a single RU. This is illustrated in FIG. 11 in which a controller may read valid data from (e.g., only from) previously referenced RUs RU A′_0, RU A′_1, and/or RU A′_2 which were written using the same RUH X and write it to an RUI 182 identified as RU α. However, in some embodiments, RU α may not receive data from RUs that were written using other reclaim handles such as RUH Y and/or RUH Z.

Similarly, a controller may read valid data from (e.g., only from) previously referenced RUs RU B′_0, RU B′_1, and/or RU B′_2 which were written using the same RUH Y and write it to an RU 1182 identified as RU β. A controller may also read valid data from (e.g., only from) previously referenced RUs RU C′_0, RU C′_1, and/or RU C′_2 which were written using the same RUH Z and write it to an RU 1182 identified as RU γ. Thus, in some embodiments, data written to one or more of the RUs 1182 may be read from (e.g., only read from) one or more RUs that were written using the same RUH.

If the valid data read from any of the previously referenced RUs 1114′ was the last remaining valid data in the RU, the RU may be erased, e.g., as part of a GC operation to be reused for storing other data.

In some embodiments, the isolation scheme illustrated in FIG. 11 may be referred to as a persistent isolation scheme because the isolation between data written using different RUHs may continue beyond the writing and/or deallocating operations, for example, to include one or more GC and/or other controller operations. In some embodiments, the isolation scheme illustrated in FIG. 11 may be referred to as a fully or totally isolated scheme because the isolation between data written using different RUHs may continue throughout the lifecycle of the data in a storage device.

Although one RG 1118 may be illustrated in FIG. 11, the RUs 1114 may be arranged in any number of RGs. In some embodiments, data from RUs in different RGs (e.g., valid data from previously referenced RUs in different RGs) may be combined in the same RU.

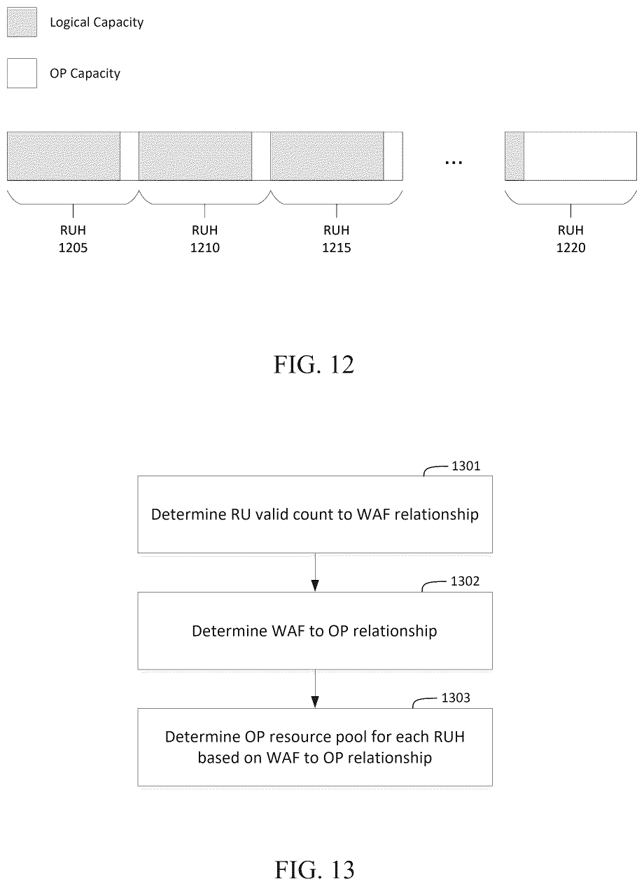

FIG. 12 illustrates an example storage configuration in accordance with example embodiments of the disclosure.

Referring to FIG. 12, the storage configuration may include one or more RUH allocations (e.g., RUH 1205, RUH 1210, RUH 1215, to RUH 1220). As shown, a given RUH allocation may include a logical capacity and an over-provisioning (OP) capacity. OP capacity in memory may include reserving extra storage space beyond the user-accessible capacity to enhance performance, improve endurance, and support internal operations like GC and wear leveling. This extra space allows a controller to manage write operations more efficiently, leading to a longer lifespan and more consistent write speeds. In some cases, an OP capacity may be based on a default OP capacity. In some cases, an RUH may not utilize an OP capacity for all operations.

Storage configuration shown in FIG. 12 may depict an example embodiment of transitioning an RUH from sequential writes operations to random write operations. In some cases, an RUH (e.g., a depicted RUH of storage configuration) may be or include a new append point in a given storage device. In some cases, a host may use characterization of write behavior per RUH to understand a drive's WAF. For example, for a storage device with WAF=1, there may be WAF=1 on one or more (e.g., each) RUH of the storage device. However. WAF improvements on at least one RUH may benefit a larger portion of (e.g., an entire portion) of a storage drive.

In some examples, a relatively low WAF can be achieved based on probabilities. For example, a relatively high OP may correlate to a relatively low WAF. In some cases, a relatively low WAF may be achieved based on one or more RUHs allowing another RUH to consume a relatively high portion of OP (e.g., all OP in a drive may be allocated to an RUH). For example, one or more RUHs associated with sequential write operations may allow an RUH associated with random write operations to consume a relatively high portion of OP.

Based on the systems and methods described, RUH 1220 may be allocated a relatively small logical capacity while maintaining a relatively large physical capacity in RUH 1220. In some cases, a host may obtain access to a storage device with a preconfigured physical storage capacity, a preconfigured logical storage capacity mapped to the physical storage capacity, and a preconfigured OP capacity based on a ratio or percentage of the physical storage capacity (e.g., 5%, 7%, 10%, or 12% physical storage capacity, etc.). In some cases, a host may assign a first portion of the logical storage capacity to RUH 1215 and a second portion of the logical storage capacity to RUH 1220. The host may select RUH 1220 to manage random write operations based on identifying random write operations on the storage device. In some cases, the host may determine that RUH 1220 is performing random write operations and assign the write operations to RUH 1220 accordingly. Based on the selection of RUH 1220, the host may reduce the logical storage capacity of RUH 1220, while the physical storage capacity of RUH 1220 is maintained (e.g., or increased). For example, RUH 1220 may be configured with a logical storage capacity that is similar to the depicted logical storage capacity of RUH 1205, RUH 1210, or RUH 1215 (e.g., a logical storage capacity that is relatively large compared to an OP capacity). The logical storage capacity of RUH 1205, RUH 1210, and/or RUH 1215 may be a multiple (e.g., 2×, 3×, 5×, 10×, 15×, 20×, etc.) of an OP capacity of RUH 1205, RUH 1210, and/or RUH 1215. In some cases, an initial logical storage capacity of RUH 1220 may be a multiple of an OP capacity of RUH 1220. However, based on the identification of random write operations, the host may reduce (e.g., shrink) the logical storage capacity of RUH 1220 as shown. Based on the selection of RUH 1220 for random write operations, the host may assign to RUH 1220 at least some portion of an available amount (e.g., a maximum available amount) of the OP capacity (e.g., a majority of the OP capacity assigned to the underlying storage device, at least half of the OP capacity assigned to the underlying storage device, all or nearly all the OP capacity assigned to the underlying storage device). Additionally, or alternatively, based on the SSD recognizing the lower WAF behavior (e.g., WAF=1 behavior) of RUHs 1205, 1210, and/or 1215, the SSD may allocate more OP to RUH 1220.

In some embodiments, initially isolated RUHs (e.g., as illustrated in FIG. 10) may share a pool of OP storage units (e.g. RUs). For example, each of RUH X, RUH Y. and RUH Z, as illustrated in FIG. 10, may be allocated OP storage from a same OP pool of storage units.

For initially isolated RUHs that share a pool of OP storage units. GC may be triggered when any RUH (e.g., RUH X. RUH Y, or RUH Z) requires a new RU for a next write operation.

In some embodiments, persistently isolated RUHs (e.g., as illustrated in FIG. 11) may share a pool of OP storage units. For example, each of RUH X, RUH Y, and RUH Z, as illustrated in FIG. 11 may be allocated OP storage from a same OP pool of storage units.

For persistently isolated RUHs that share a pool of OP storage units, GC may be triggered when any RUH (e.g., RUH X, RUH Y, or RUH Z) requires a new RU for a next write operation. In some embodiments, RUs of a same RUH may only be evaluated for consideration of GC. That is, if RUH Y needs a new RU for a next write operation, GC will not be triggered for RUH X or RUH Z.

In some embodiments, RUs of a different RUH may be evaluated for consideration of GC. That is, if RUH Y needs a new RU for a next write operation, GC may be triggered for RUH X or RUH Z.

In some embodiments, persistently isolated RUHs (e.g., as illustrated in FIG. 11) may be allocated OP storage from separate, equal OP pools of storage units, wherein each of the separate, equal OP pools is distinct from each other. That is, OP storage units are not shared among the pools. For example, RUH X, as illustrated in FIG. 11 may be allocated OP storage from a first OP pool of storage units, RUH Y may be allocated OP storage from a second OP pool of storage units, and RUH Z may be allocated OP storage from a third OP pool of storage units, where each of the first, second, and third OP pools has the same amount of storage units.

For persistently isolated RUHs that are allocated OP storage from separate, equal OP pools of storage units. GC may be triggered when any RUH (e.g., RUH X, RUH Y, or RUH Z) requires a new RU for a next write operation. However, RUs of a same RUH may only be evaluated for consideration of GC. That is, if RUH Y needs a new RU for a next write operation, GC will not be triggered for RUH X or RUH Z.

In some embodiments, persistently isolated RUHs (e.g., as illustrated in FIG. 11) may be allocated OP storage from separate OP pools of storage units, based on the amount of logical capacity written to an RUH, wherein each of the separate OP pools is distinct from each other. That is, OP storage units are not shared among the pools. For example, RUH X, as illustrated in FIG. 11 may be allocated OP storage from a first OP pool of storage units, RUH Y may be allocated OP storage from a second OP pool of storage units, and RUH Z may be allocated OP storage from a third OP pool of storage units, where each of the first, second, and third OP pools has differing amounts of storage units based on the respective capacities of the RUHs. However, if RUH X, RUH Y, or RUH Z have the same capacities, then OP storage allocation may be the same as for persistently isolated RUHs being allocated OP storage from separate, equal OP pools of storage units, as described above.

For persistently isolated RUHs that are allocated OP storage from separate OP pools of storage units, based on an amount of logical capacity written to an RUH, GC may be triggered when any RUH (e.g., RUH X. RUH Y, or RUH Z) requires a new RU for a next write operation. However, RUs of a same RUH may only be evaluated for consideration of GC. That is, if RUH Y needs a new RU for a next write operation. GC will not be triggered for RUH X or RUH Z.

In some embodiments, persistently isolated RUHs (e.g., as illustrated in FIG. 11) may be allocated OP storage from separate OP pools of storage units, based on an amount of logical capacity written to an RUH, e.g., logical capacity of each RUH, wherein each of the separate OP pools is distinct from each other. That is, OP storage units are not shared among the pools. For example, RUH X, as illustrated in FIG. 11 may be allocated OP storage from a first OP pool of storage units, RUH Y may be allocated OP storage from a second OP pool of storage units, and RUH Z may be allocated OP storage from a third OP pool of storage units, where each of the first, second, and third OP pools has differing amounts of storage units based on the respective capacities of the RUHs. The sizes of the first, second, and third OP pools may be respectively proportional to the logical capacities written to RUH X, RUH Y, and RUH Z. However, if RUH X, RUH Y, and RUH Z received the same amount of logical capacity writes, then OP storage allocation may be the same as for persistently isolated RUHs being allocated OP storage from separate, equal OP pools of storage units, as described above.

For persistently isolated RUHs that are allocated OP storage from separate OP pools of storage units, based on an amount of logical capacity written to an RUH, GC may be triggered when any RUH (e.g., RUH X, RUH Y, or RUH Z) requires a new RU for a next write operation. However, RUs of a same RUH may only be evaluated for consideration of GC. That is, if RUH Y needs a new RU for a next write operation, GC will not be triggered for RUH X or RUH Z.

In some embodiments, persistently isolated RUHs (e.g., as illustrated in FIG. 11) may be allocated OP storage from separate OP pools of storage units, based on a WAF of each RUH, wherein each of the separate OP pools is distinct from each other. That is, OP storage units are not shared among the pools. For example, RUH X, as illustrated in FIG. 11 may be allocated OP storage from a first OP pool of storage units. RUH Y may be allocated OP storage from a second OP pool of storage units, and RUH Z may be allocated OP storage from a third OP pool of storage units, where each of the first, second, and third OP pools has differing amounts of storage units based on the respective WAFs of the RUHs. The sizes of the first, second, and third OP pools may be respectively proportional to the WAFs of RUH X, RUH Y. and RUH Z. However, if RUH X, RUH Y, and RUH Z have the same WAFs, then OP storage allocation may be the same as for persistently isolated RUHs being allocated OP storage from separate, equal OP pools of storage units, as described above.

FIG. 13 illustrates a method performed by a storage device in accordance with example embodiments of the disclosure. More specifically, FIG. 13 illustrates an example of determining separate OP pools of storage units for each persistently isolated RUH based on a WAF of each RUH.

Referring to FIG. 13, in step 1301, an RU valid page count (VPC) to WAF relationship is determined. That is, as a VPC of an RU in an RUH relates to a WAF of the RUH, the relationship of the VPC of the RU to the WAF may be used to determine the WAF of the RUH. In some embodiments, the VPC may relate to the WAF in a relationship such as (WAF−1)/WAF=VPC. Alternatively in some embodiments, the invalid page count (IPC) may be used with a relationship to WAF of 1/WAF=IPC.

In step 1302, a WAF to OP relationship is determined. In some embodiments, the WAF to OP relationship may follow the equation WAF=(1+OP)/((1+OP)+lambert(−(1+OP)*EXP(−(1+OP)))) where ‘lambert’ is the Lambert Equation. In some embodiments, an amount of OP storage units included in an OP storage pool for an RUH may be linearly proportional to the RUH's WAF. For example, a WAF=1 may correspond to 0% of available OP storage units for inclusion into the OP storage pool, whereas WAFs=2 and 3 may respectively correspond to 25% and 50% of available OP storage units for inclusion into the OP storage pool. Alternatively, an amount of OP storage units included in an OP storage pool for an RUH may not be linearly proportional to the RUH's WAF, e.g., may follow an exponential curve, and/or may be modified based on a number of active RUHs.

In step 1302, an OP resource pool is determined for each RUH based on the WAF to OP relationship.

For persistently isolated RUHs that are allocated OP storage from separate OP pools of storage units, based on RUH WAF, GC may be triggered when any RUH (e.g., RUH X, RUH Y, or RUH Z) requires a new RU for a next write operation.

GC may also be triggered by other conditions. For example, GC may also be triggered in response to a minimum threshold of available RUs for future incoming writes dropping below a threshold. These rules may be applied within an RG or other boundary of the SSD storage media. However, RUs of a same RUH may only be evaluated for consideration of GC. That is, if RUH Y needs a new RU for a next write operation. GC will not be triggered for RUH X or RUH Z.

In some embodiments, persistently isolated RUHs (e.g., as illustrated in FIG. 11) may be allocated OP storage from separate OP pools of storage units, based on a WAF of each RUH and an additional modifier, wherein each of the separate OP pools is distinct from each other. That is, in addition to using the WAF of each RUH as described above, an additional modifier, such as an amount of logical capacity written to an RUH. RUH average write command rate, RUH average write throughput, reads accessing data previously written by an RUH, etc., may be utilized to determine the separate OP pools of storage units for each RUH.

For FDP, each RUH may append data into a different RU. As writes enter a drive and are directed to an RUH, each RU associated with the RUH as an append point will then fill. Thus, it is possible to identify an RU as being associated to the RUH that wrote and filled the RU with data.

In initially isolated RUHs, a GC process of RUs may mix data. As a result, data that was initially written with an RUH into an RU may be mixed with data that was previously written by another RUH. However, in persistently isolated RUHs, GC processes may only mix data written by the same RUH. Due to a restriction of RUHs writing data into a separated set of RUs and the GC process only acting on data that was written by the same RUH, GC on the RUH may include a GC action occurring on all of the RUs previously written with data using the same RUH identifier. Accordingly, herein, the terminology “perform GC in an RUH” may be used to describe GC of data on a subset of RUs written by the same RUH.

When GC is occurring within an RUH, for this RUH, each of RUs previously written using this RUH identifier may be examined, and an RU (e.g., a first RU) may be selected, as will be described below in more detail.

After selecting the first RU to be GC'ed, remaining valid data is read out of the first RU. The valid data is then written into a new RU, which may be associated with the same RUH for easier tracking. Because a “new RU” is utilized, a reserve number of empty RUs may be kept by an SSD.

After all of the valid data is read out of the first RU selected for GC, then that the first RU may be erased.

According to an embodiment, EBs of the first RU may be released into a “free pool” of EBs. Additionally, a new RU may be composed of blocks within the free pool. Further, each new RU may be composed of different sets of EBs each time a new RU is created.

If it is determined the GC activity is sufficient (e.g., the GC created enough free RUs to increase the free pool sufficiently), then the GC process may terminate. However, if more GC is required, then a second RU may be selected for GC. The second RU may have its remaining valid data read to the same new RU as the last GC activity for the first RU or potentially a second new RU associated with the GC process of the first RU as the remaining valid data might overflow into another new RU.

The above descriptive example assumes a single RG configuration. However, the operation proceeds similarly within each RG when there are multiple RGs. A boundary of examining RUs for GC will remain within a boundary of each of the RGs. Further, where the above descriptive example refers to storage units in “each RUH”, in a multiple RG configuration, it would refer to “each RG and RUH combination”.

In some embodiments, to perform GC in an RUH, a least valid RU, i.e., an RU with a lowest VPC that was previously written by an RUH, or fastest invalidating RU among the RUs included in the RUH may be selected for GC. Similarly, an RU in an RUH may be selected for GC based on not meeting a minimum VPC or not being within a threshold of an average VPC of all of the RUs in the RUH or corrected average VPC (i.e., the average VPC minus VPCs of an actively filling RU and an RU actively being GC'ed.

An SSD may determine to perform GC various ways. For example, the SSD may determine that GC is to be performed if more EBs should be added to the free pool, e.g., in response to a number of EBs in the free pool falling below a predetermined threshold. This addition of EBs to the free pool will allow the future creation of more new RUs, as described above.

Alternatively, GC may be triggered in order to create more new empty RUs. These empty/new RUs may be used optionally for receiving GC data during an RUH GC activity and/or receiving new incoming host data associated with an RUH.

After determining to perform GC, selections may be made as to which RUH will begin the GC activity, and as to, within the RUH, which of the RUs previously written by the RUH will be GC'ed. These selections may be performed in any order.

A selection of an RUH for GC activity can be done in various ways. For example selection of an RUH may be based on an amount of physical capacity consumed by an RUH, an amount of physical capacity in comparison to an amount of logical capacity (e.g., there are many RUs that are full, but the RUs have accumulated a large number of invalids as logical LBAs are written into different RUs elsewhere), a length of time since data was written using an RUH, an average length of time since data was written to an RUH, a filtered or averaged number of write commands directed to an RUH (e.g., write input/output operations per second (IOPS) per RUH), a size of commands written to an RUH, a number of and size of commands written to an RUH (e.g., write BW per RUH), a length of time since a read to data contained in RUs previously written by an RUH was read, read IOPS per RUH, read BW per RUH, combined IOPS per RUH, combined IOPS per RUH, a deallocation or trim rate (IOPS or BW) that occurs to data previously written to an RUH, a rate of invalidation of data written to an RUH (e.g., if LBA was written to an RUH and then the same LBA was written again layer, this LBA could be written to the same RUH or a different RUH, and in both cases the old data remains in an RU now counted as invalid), an RUH lifespan, etc., or a combination of any of above, such as a length of time since a last write to an RUH compared to an average length of time since data previously written by the RUH was written being multiplied by a ratio of logical capacity to physical capacity associated with data written to the RUH.

Generally, there are many RUHs, and these types of values may be generated for every RUH or a subset of the RUHs. For example, sometimes there are insufficient computational resources to compute these values for every RUH, and as such, values may be computed for all RUHs until time expires and then a best answer may be selected. Thereafter, the values may be compared in order to select the RUH that will initiate a GC operation.

Similarly, selection of an RU within an RUH for GC activity can be done in various ways. For example selection of an RU within an RUH may be based on an amount of physical capacity consumed by an RU within an RUH, an amount of physical capacity in comparison to an amount of logical capacity (e.g., there are many RUs that are full, but the RUs have accumulated a large number of invalids as logical LBAs are written into different RUs elsewhere), a length of time since data was written to an RU within an RUH, an average length of time since data was written to an RU within an RUH, a filtered or averaged number of write commands directed to an RU within an RUH (e.g., write input/output operations per second (IOPS) per RU within the RUH), a size of commands written to an RU within an RUH, a number of and size of commands written to an RU within an RUH (e.g., write BW per RU), a length of time since a read to data contained in an RU within an RUH, read IOPS per an RU within an RUH, read BW per an RU within an RUH, combined IOPS per an RU within an RUH, combined IOPS per an RU within an RUH, a deallocation or trim rate (IOPS or BW) that occurs to data previously written to an RU within an RUH, a rate of invalidation of data written to an RU within an RUH (e.g., if LBA was written to an RU within the RUH and then the same LBA was written again layer, this LBA could be written to the same another RU within the RUH or a different RUH, and in both cases the old data remains in an RU now counted as invalid), a lifespan of an RU within an RUH, etc., or a combination of any of above.

As indicated above, a selection of an RUH to GC may precede a selection of an RU to GC. However, there is a possibility that RU information informs a decision on which RUH to GC. Additionally, the selections can sometimes be done in parallel with potential comparisons. For example, out of many RUHs that could potentially be GC'ed, if 2 are found to be close on a metric of comparison, e.g., within a predetermined threshold of each other, RUs previously written by the RUHs may be examined for GC. Thereafter, a selection of an RU to GC may be made within each of the RUHs.

After an RU is selected in each of the RUHs, a comparison of the 2 RUs may be made.

It is also possible to use one set of metrics to select the RUs within the RUHs, and then use a different set of metrics to compare the 2 RUs that are identified between the 2 RUHs.

In another example there may be a metric of for selecting the 10 least valid RUs within each RUH, and out of those 10 least valid RUs per RUH, there may be another metric, e.g., invalidation rate generated for those 10 RUs previously written by each RUH. This comparison of invalidation rate of a subset of RUs may be used to determine the RUH for the GC activity. Additionally, it is possible that more complex combinations can be created and used (e.g., artificial intelligence (AI) may be used to perform more complex metric selections).

In some embodiments, an RU among the RUs included in an RUH may be selected for GC based on lifespan, e.g., using a lifespan-based GC algorithm that selects an RU including data with the shortest expected lifespan for GC. That is, by understanding the lifespans of data in RUs, the most appropriate RU may be selected for GC, leading to reduced WAF and improved overall storage performance.

In some embodiments, an RU among the RUs included in an RUH may be selected for GC based on write rates of the RUs. For example, an RU with a lowest write rate, a highest write rate, or a write rate that does not meet a particular threshold, e.g., an average write rate of an RUH, may be selected among the RUs in the RUH for GC.

In some embodiments, to optimize RU selection for a GC process, certain RUs may be removed or excluded from GC consideration, i.e., cannot be selected for GC. For example, an RU may be removed from GC consideration based on overwrites or trims invalidating above a threshold.

Alternatively, an RU may be removed from GC consideration, for example, based on:
a first ratio of an invalidation count of the RU over a time period to host IOs over the time period being compared to a first threshold for the first ratio;
a second ratio of an invalidation count of the RU over a time period to host BW over the time period being compared to a second threshold for the second ratio; or
a third ratio of an invalidation count of the RU to a time period being compared to a third second threshold for the second ratio.

Herein, the invalidation count may refer to a metric or counter that tracks how often data is removed from a memory because it is no longer valid or up-to-date.

As yet another alternative, a relative rate of invalidation among RUs in an RUH may be used to remove certain RUs from GC consideration. For example, the invalidation rates of all RUs in an RUH may be compared and a predetermined number of RUs with the highest invalidation rates may be removed from GC consideration.

Further, AI operations, such as comparing recent invalidation rates to a long running low pass value (e.g., low pass, running weighted average, continuous average, etc.) may be utilized to remove certain RUs from GC consideration.

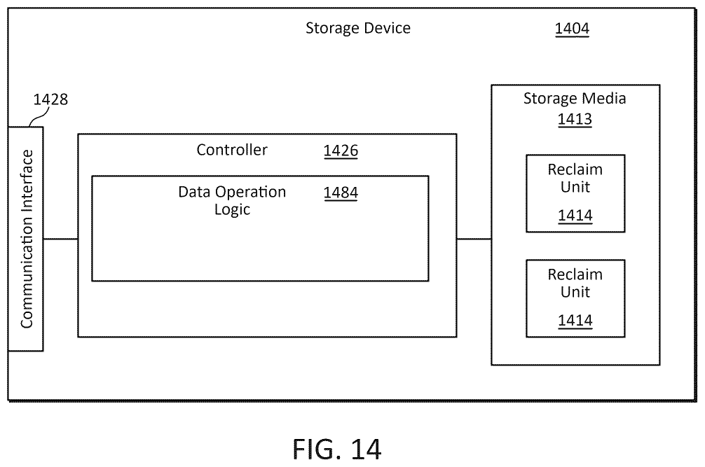

FIG. 14 illustrates another embodiment of a storage device with FDP in accordance with example embodiments of the disclosure.

Referring to FIG. 14, the storage device 1404 may include storage media 1413 and a controller 1426. The storage media 1413 may include two or more RUs 1414. In some embodiments, some or all of the RUs 1414 may be arranged in RGs. The controller 1426 may include data operation logic 1484 that may receive any type of data operation request such as a request for a write operation (e.g., a write command, write zeros, write ones, write uncorrectable, and/or the like), a copy operation, a deallocate operation (e.g., an unmap, a trim, and/or the like), a sanitize operation, an erase operation, a format operation, a compare and write operation, and/or the like. The data operation logic 1484 may receive the data operation request, for example, using a communication interface 1428.

In some embodiments, the data operation request may include an indication relating to data locality in storage media such as an RUH, an RG, and/or the like. Based on receiving a data operation request with an indication relating to data locality in storage media, the data operation logic 1484 may perform a corresponding data operation, for example, on one or more of the RUs 1414, based on one or more operations and/or conditions of the storage device.

Any of the storage devices, storage media, and/or the like, disclosed herein may be implemented with any type of nonvolatile storage media based on solid state media, magnetic media, optical media, and/or the like. For example, in some embodiments, a computational storage device may be implemented as an SSD based on not-AND (NAND) flash memory, persistent memory such as cross-gridded NVM, memory with bulk resistance change, phase change memory (PCM), and/or the like, or any combination thereof.

Any of the storage devices disclosed herein may be implemented in any form factor such as 3.5 inch, 2.5 inch, 1.8 inch, M.2. Enterprise and Data Center Standard Form Factor (EDSFF), NF1, and/or the like, using any connector configuration such as Serial ATA (SATA), Small Computer System Interface (SCSI), Serial Attached SCSI (SAS), U.2, and/or the like.

Any of the storage devices disclosed herein may be implemented entirely or partially with, and/or used in connection with, a server chassis, server rack, dataroom, datacenter, edge datacenter, mobile edge datacenter, and/or any combinations thereof.

Any of the hosts disclosed herein may be implemented with any component or combination of components such as a compute server, a storage server, a network server, a cloud server, and/or the like, a node such as a storage node, a computer such as a workstation, a personal computer, a tablet, a smartphone, and/or the like, or multiples and/or combinations thereof.

Any of the communication connections and/or communication interfaces disclosed herein may be implemented with one or more interconnects, one or more networks, a network of networks (e.g., the internet), and/or the like, or a combination thereof, using any type of interface and/or protocol. Examples may include Peripheral Component Interconnect Express (PCIe), NVMe, NVMe-over-fabric (NVMe-oF), Ethernet, Transmission Control Protocol/Internet Protocol (TCP/IP), Direct Memory Access (DMA) Remote DMA (RDMA), RDMA over Converged Ethernet (ROCE), FibreChannel, InfiniBand, Serial ATA (SATA), Small Computer Systems Interface (SCSI), Serial Attached SCSI (SAS), iWARP, Compute Express Link (CXL), and/or a coherent protocol such as CXL.mem, CXL.cache, CXL.IO and/or the like, Gen-Z, Open Coherent Accelerator Processor Interface (OpenCAPI), Cache Coherent Interconnect for Accelerators (CCIX), and/or the like, Advanced eXtensible Interface (AXI), any generation of wireless network including 2G, 3G, 4G, 5G, 6G, and/or the like, any generation of Wi-Fi, Bluetooth, near-field communication (NFC), and/or the like, or any combination thereof.

Any of the functionality described herein, including any of the host functionality, storage device functionally, and/or the like (e.g., any of the storage device controllers, logic, and/or the like) may be implemented with hardware, software, firmware, or any combination thereof including, for example, hardware and/or software combinational logic, sequential logic, timers, counters, registers, state machines, volatile memories such DRAM and/or SRAM, NVM including flash memory, persistent memory such as cross-gridded NVM, memory with bulk resistance change, PCM, and/or the like and/or any combination thereof, complex programmable logic devices (CPLDs), field programmable gate arrays (FPGAs), application specific circuits (ASICs), CPUs including CISC processors such as x86 processors and/or RISC processors such as ARM processors, graphics processing units (GPUs), neural processing units (NPUs), tensor processing units (TPUs), and/or the like, executing instructions stored in any type of memory. In some embodiments, one or more components may be implemented as a system-on-chip (SOC).

In embodiments implemented at least partially with a storage device having a flash translation layer (FTL) any of the functionality described herein (e.g., any of the storage device controllers, logic, and/or the like) may be implemented at least partially with an FTL.

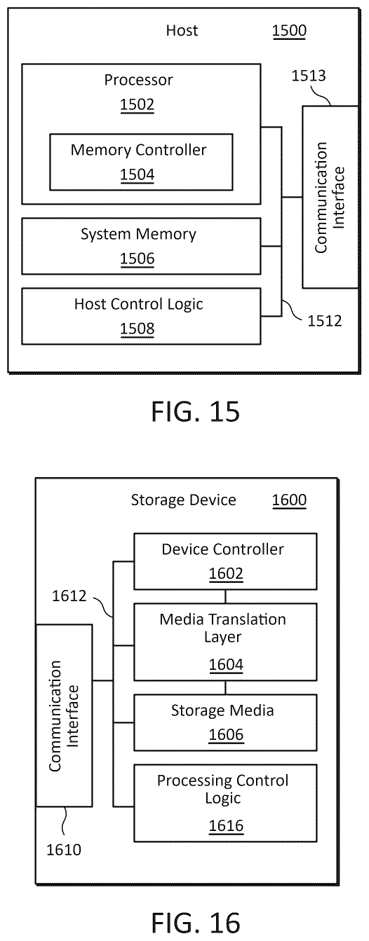

FIG. 15 illustrates an example embodiment of a host apparatus that may be used to implement any of the host functionality disclosed herein in accordance with example embodiments of the disclosure. The host apparatus 1500 illustrated in FIG. 15 may include a processor 1502, which may include a memory controller 1504, a system memory 1506, host control logic 1508, and/or a communication interface 1513. Any or all of the components illustrated in FIG. 15 may communicate through one or more system buses 1512. In some embodiments, one or more of the components illustrated in FIG. 15 may be implemented using other components. For example, in some embodiments, the host control logic 1508 may be implemented by the processor 1502 executing instructions stored in the system memory 1506 or other memory.

FIG. 16 illustrates an example embodiment of a storage device that may be used to implement any of the storage device functionality disclosed herein in accordance with example embodiments of the disclosure. The storage device 1600 may include a device controller 1602, a media translation layer 1604 (e.g., an FTL), a storage media 1606, feature logic 1616 (which may be used, for example, to implement any of the logic disclosed in FIG. 7 and/or FIG. 8), and a communication interface 1610. The components illustrated in FIG. 16 may communicate through one or more device buses 1612. In some embodiments that may use flash memory for some or all of the storage media 1606, the media translation layer 1604 may be implemented partially or entirely as a flash translation layer (FTL).

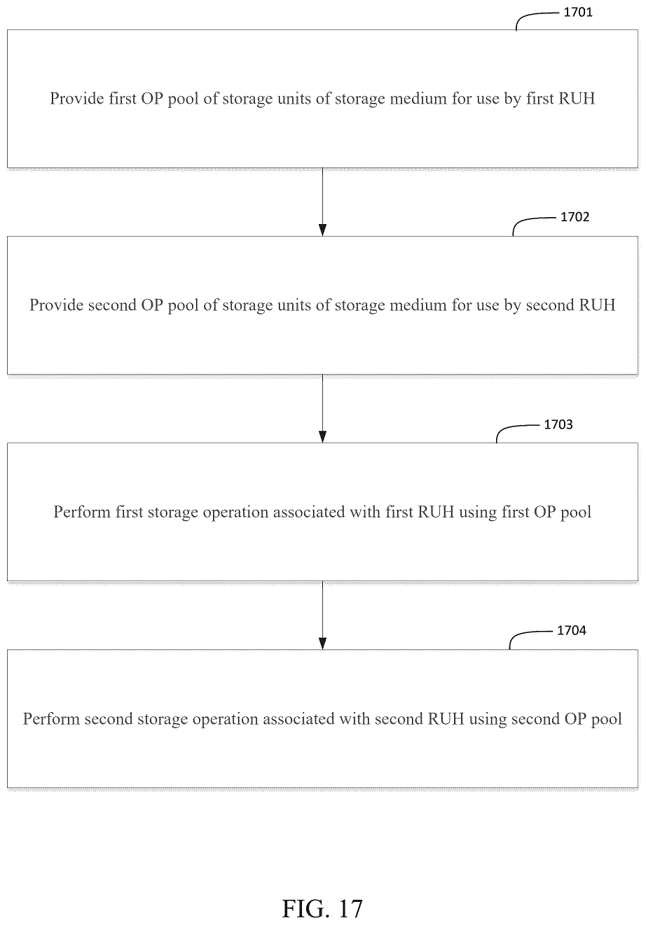

FIG. 17 illustrates an embodiment of a method performed a storage device in accordance with example embodiments of the disclosure.

Referring to FIG. 17, in step 1701, the storage device, e.g., storage device 704, 804, 904, 1404, or 1600 may provide a first OP pool of storage units of a storage medium for use by a first RUH.

In step 1702, the storage device may provide a second OP pool of storage units of the storage medium for use by a second RUH. The first OP pool and the second OP pool may be distinct from each other.

In step 1703, the storage device may perform a first storage operation associated with the first RUH using the first OP pool.

In step 1704, the storage device may perform a second storage operation associated with the second RUH using the second OP pool.

The embodiment illustrated in FIG. 17, as well as all of the other embodiments described herein, are example operations and/or components. In some embodiments, some operations and/or components may be omitted and/or other operations and/or components may be included. Moreover, in some embodiments, the temporal and/or spatial order of the operations and/or components may be varied. Although some components and/or operations may be illustrated as individual components, in some embodiments, some components and/or operations shown separately may be integrated into single components and/or operations, and/or some components and/or operations shown as single components and/or operations may be implemented with multiple components and/or operations.

While embodiments have been described above with reference to a storage device that may implement an FDP scheme, because a storage device that does not implement an FDP scheme, i.e., with no FDP features, may operate the same ways a storage device that may implement an FDP scheme with only 1 persistently isolated RUH, the above described embodiment may also be applicable to a storage device that does not implement an FDP scheme. Furthermore, since a storage device with no FDP features is not often described using in the terminology of RU and RUH, it is noted an RU and RUH may be referred to as a superblock and an append point in the storage device with no FDP features.

Some embodiments disclosed above have been described in the context of various implementation details, but the principles of this disclosure are not limited to these or any other specific details. For example, some functionality has been described as being implemented by certain components, but in other embodiments, the functionality may be distributed between different systems and components in different locations and having various user interfaces. Certain embodiments have been described as having specific processes, operations, etc., but these terms also encompass embodiments in which a specific process, operation, etc. may be implemented with multiple processes, operations, etc., or in which multiple processes, operations, etc. may be integrated into a single process, step, etc. A reference to a component or element may refer to only a portion of the component or element. For example, a reference to a block may refer to the entire block or one or more subblocks. A reference to a component or element may refer to one or more of the component or element, and a reference to plural components or elements may refer to a single component or element. For example, a reference to a resource may refer to one more resources, and a reference to resources may refer to a single resource. The use of terms such as “first” and “second” in this disclosure and the claims may only be for purposes of distinguishing the elements they modify and may not indicate any spatial or temporal order unless apparent otherwise from context. In some embodiments, a reference to an element may refer to at least a portion of the element, for example, “based on” may refer to “based at least in part on.” and/or the like. A reference to a first element may not imply the existence of a second element. The principles disclosed herein have independent utility and may be embodied individually, and not every embodiment may utilize every principle. However, the principles may also be embodied in various combinations, some of which may amplify the benefits of the individual principles in a synergistic manner. The various details and embodiments described above may be combined to produce additional embodiments according to the inventive principles of this patent disclosure.

Since the inventive principles of this patent disclosure may be modified in arrangement and detail without departing from the inventive concepts, such changes and modifications are considered to fall within the scope of the following claims.

What is claimed is:

1. An apparatus comprising:
a storage device comprising:
a storage medium, and
a controller configured to:
provide a first over-provisioning (OP) pool of storage units of the storage medium for use by a first reclaim unit handle (RUH);
provide a second OP pool of storage units of the storage medium for use by a second RUH, wherein the first OP pool and the second OP pool are distinct from each other;
perform a first storage operation associated with the first RUH using the first OP pool; and
perform a second storage operation associated with the second RUH using the second OP pool.

2. The apparatus of claim 1, wherein the first OP pool and the second OP pool include a same number of storage units.

3. The apparatus of claim 1, wherein data from each of the first RUH and the second RUH remains isolated from other RUHs.

4. The apparatus of claim 3, wherein the first OP pool includes a first number of storage units, and
wherein the second OP pool includes a second number of storage units.

5. The apparatus of claim 4, wherein the first number of storage units is based on a capacity of the first RUH, and
wherein the second number of storage units is based on a capacity of the second RUH.

6. The apparatus of claim 4, wherein the first number of storage units is based on a write amplification factor (WAF) of the first RUH, and
wherein the second number of storage units is based on a WAF of the second RUH.

7. The apparatus of claim 4, wherein the first number of storage units is based on a write amplification factor (WAF) of the first RUH and a first additional modifier, and
wherein the second number of storage units is based on a WAF of the second RUH and a second additional modifier.

8. The apparatus of claim 7, wherein the first additional modifier comprises at least one of a capacity of the first RUH, an average write rate of the first RUH, or an average write throughput of the first RUH, and
wherein the second additional modifier comprises at least one of a capacity of the second RUH, an average write rate of the second RUH, or an average write throughput of the second RUH.

9. The apparatus of claim 1, wherein the controller is further configured to perform a garbage collection (GC) operation for the first RUH or the second RUH.

10. The apparatus of claim 9, wherein the controller is further configured to perform the GC operation for the first RUH or the second RUH by selecting a least valid storage unit utilized by the first RUH or the second RUH.

11. The apparatus of claim 9, wherein the controller is further configured to perform the GC operation for the first RUH or the second RUH by selecting a fastest invalidating storage unit utilized by the first RUH or the second RUH.

12. The apparatus of claim 9, wherein the controller is further configured to perform the GC operation for the first RUH or the second RUH by determining at least one of a write amplification factor (WAF) or OP based on a number of invalidation counts of the first RUH or the second RUH.

13. The apparatus of claim 9, wherein the controller is further configured to perform the GC operation for the first RUH or the second RUH by selecting a storage unit utilized by the first RUH or the second RUH that includes data having a shortest expected lifespan.

14. The apparatus of claim 9, wherein the controller is further configured to exclude a storage unit utilized by the first RUH or the second RUH from consideration for the GC operation, based on a rate of invalidation of the storage unit.

15. The apparatus of claim 14, wherein the controller is further configured to exclude the storage unit, based on the rate of invalidation of the storage unit, by comparing a ratio of an invalidation count of the storage unit over a time period to host inputs and/or outputs (IOs) over the time period to a threshold for the ratio.

16. The apparatus of claim 14, wherein the controller is further configured to exclude the storage unit, based on the rate of invalidation of the storage unit, by comparing a ratio of an invalidation count of the storage unit over a time period to host bandwidth over the time period to a threshold for the ratio.

17. The apparatus of claim 14, wherein the controller is further configured to exclude the storage unit, based on the rate of invalidation of the storage unit, by comparing a ratio of an invalidation count of the storage unit to a time period to a threshold for the ratio.

18. The apparatus of claim 14, wherein the controller is further configured to exclude the storage unit, based on the rate of invalidation of the storage unit, by comparing the rate of invalidation of the storage unit to rates of invalidation of other storage units utilized by the first RUH or the second RUH.

19. A method performed by a storage device including a storage medium, the method comprising:
providing a first over-provisioning (OP) pool of storage units of the storage medium for use by a first reclaim unit handle (RUH);
providing a second OP pool of storage units of the storage medium for use by a second RUH, wherein the first OP pool and the second OP pool are distinct from each other;
performing a first storage operation associated with the first RUH using the first OP pool; and
performing a second storage operation associated with the second RUH using the second OP pool.

20. An apparatus comprising:
a storage device comprising:
a storage medium, and
a controller configured to:
provide an over-provisioning (OP) pool of storage units of the storage medium for use by a first reclaim unit handle (RUH) and a second RUH:
perform a first storage operation associated with the first RUH using the OP pool of storage units; and
perform a second storage operation associated with the second RUH using the OP pool of storage units.
